(19) United States
(12) Patent Application Publication
(10) Pub. No.: US 2011/0131299 A1
(43) Pub. Date: Jun. 2, 2011

(54) NETWORKED MULTIMEDIA ENVIRONMENT ALLOWING ASYNCHRONOUS ISSUE TRACKING AND COLLABORATION USING MOBILE DEVICES

(76) Inventor: Babak Habibi Sardary, North Vancouver (CA)

(21) Appl. No.: 12/956,899

(22) Filed: Nov. 30, 2010

Related U.S. Application Data
(60) Provisional application No. 61/265,268, filed on Nov. 30, 2009.
(60) Provisional application No. 61/289,902, filed on Dec. 23, 2009.

(51) Int. Cl. G06F 15/16

(52) U.S. Cl. 709/219

(57) ABSTRACT

Online collaboration using multimedia content may be implemented by a server communicatively coupled to mobile computing devices such as smart phones and PDAs, as well as desk top computing systems. Users may create memorandums using a variety of different types of content. The memorandums may address particular issues, for example a project, issue, or trouble tracking item. Users can create stories for the memorandums, for example narrating or otherwise explaining elements of the issue, replicating a face-to-face discussion in an asynchronous manner.

### CROSS REFERENCE TO RELATED APPLICATIONS

This application claims benefit under 35 U.S.C. 119(e) to U.S. provisional patent application Ser. No. 61/265,268 filed Nov. 30, 2009; and U.S. provisional patent application Ser. No. 61/289,902 filed Dec. 23, 2009, both of which are incorporated herein by reference in their entireties.

### BACKGROUND

1. Technical Field

The present disclosure in some respects relates to issue tracking or trouble ticket systems which allow on-line collaboration to address issues, for example issues in the release of software, other products or the provision of services, and in other respects may have broader applications.

2. Description of the Related Art

The past several years have witnessed the evolution and mass commercialization of so-called smart phone devices at increasingly affordable prices and expanding feature sets. These devices are increasingly equipped with an array of electronic sensors including cameras for capturing digital still images and digital video, as well as sensors for detecting movement, temperature and location, etc.

Mobile workers, who today make up over 75% of the workforce in developed nations, spend more than 20% of their work day away from the office visiting project sites and plants, inspecting work in progress and communicating with customers, contractors and partners. In the course of such activities, situations often arise that require taking of notes, collection of multimedia data and subsequent follow-up and collaboration with others. The collection, dissemination and collaboration of such data is currently handled through ad-hoc combinations of methods and tools. Most such professionals still rely on a patchwork of paper notes, electronic documents, digital pictures, email and voicemail to document a given subject and to communicate with others. These methods are inefficient and error-prone.

The new generation of smart phone devices provides an ideal platform for gathering and transmission of multimedia data at the source of subjects, issues and/or situations. Smart phone note and memorandum taking software applications available today are designed for personal use and typically allow recording of single media memorandums (e.g., text or audio). Combining single media memorandums into cohesive ones is a manual and time-consuming and error-prone process. Existing applications do not provide efficient means for sharing of, and collaboration upon the collected data which is a key aspect for many users. Furthermore, these applications do not provide a standard method for describing subjects, issues and/or situations in a natural or direct manner. Thus, different approaches are desirable.

### BRIEF SUMMARY

The approaches described herein may eliminate the need for manual acts currently needed to assemble and cross-reference disparate multimedia data related to a given subject and/or issue. This is accomplished by enabling a collection of multimedia data items in the context of a memorandum object. The approaches described herein may enable users to describe the nature of the subject or issue at hand in a manner similar to an in-person meeting. The approaches described herein may further enable users other than the originating user (collaborating users) to utilize a symmetrical set of tools to continue a discussion until the subject or issue is brought to a conclusion or resolution. With these facilities, an originating user may use any processor-based device which may be convenient at the time including a connected mobile computing device (e.g., personal digital assistant or smart phone) to collect the base multimedia data for the memorandum, and then develop a story about the given subject, issue and/or situation. This user can then share the collected media and developed story(s) with other users with whom the user wishes to collaborate. The collaborating users can then view the collected media and story(s) and comment upon such or alternatively provide detailed replies by creating and transmitting their own story(s) related to the memorandum.

A method of operating a server in a networked collaborative environment may be summarized as including receiving a first memorandum creation request to create a first memorandum at the server via a network from a first end user processor-based device remotely located from the server; and in response to receiving the first memorandum creation request, creating a first memorandum record by the server, the first memorandum record corresponding to the first memorandum, the first memorandum record including metadata specifying at least one of a title or a description of a subject of the first memorandum and at least one content item reference specifying at least one content item of the first memorandum; creating at least one content item record including metadata specifying at least one of a date, a time or a geographical location and a reference to a piece of content with a content type selected from audio content, still image content, video content, document content and a Web content; creating at least one media record including an original source data file reference and at least one pointer to a set of source data; and providing a notification of the availability of the first memorandum from the server via a network to at least a second end user processor-based device remotely located from the server, the second end user processor-based device different from the first end user processor-based device.

The method may further include receiving a first story creation request to create a first story associated with the first memorandum at the server via a network from a first end user processor-based device remotely located from the server; and in response to receiving the first story creation request, creating a first story record by the server, the first story record corresponding to the first story, the first story record including a time index and a mapping of a number of pieces of content and a number of media objects created by a user to the time index. The media objects may include at least one of a video file, an audio file, a visual annotation or a drawing created by the user and related to the at least one piece of content. Creating a first story record by the server may include creating the first story record including a set of metadata specifying at least one of a date, a time, or a geographic location associated with the first story. Creating a first story record by the server may include creating the first story record including an ambient parameter or a set of user credentials. The method may further include providing a notification of the availability of the first story from the server via the network to at least a second end user processor-based device remotely located from the server, the second end user processor-based device different from the first end user processor-based device. Creating a first story record by the server may include creating a screen annotation record that identifies a screen annotation created by the user. Creating a first story record by the server may include creating a screen annotation record that identifies a screen annotation in the form of at least one of a label, reference to a graphic file, or reference to an animation file created by the user. Creating a first story record by the server may include creating drawing data record including a time-indexed array of screen coordinates traversed by the user. The method may further include outputting at least one story in a format employed by at least one third party social networking or group collaboration service or site.

A method of operating a first end user processor-based device in a networked collaborative environment may be summarized as including presenting a memorandum specification user interface on a display of the first end user processor-based device, the memorandum specification user interface including at least one metadata specification field configured to allow a user to enter metadata for a memorandum in the form of at least one of a title or a description of the memorandum, at least one content specification field configured to allow the user to specify at least one piece of content for the memorandum where a type of content selectable by the user includes still image content, video image content, audio content, document content, and electronic mail content, and at least one participant specification field configured to allow the user to identify each of a number of participants having authority to at least one of view, modify or respond to the memorandum; receiving a number of user selections indicative of the metadata, the at least one piece of content and the at least one participant for the memorandum; and transmitting a memorandum specification request to a processor-based server remotely located from the first end user processor-based device, the memorandum specification request specifying the at least one piece of content and the at least one participant for the memorandum.

The method may further include presenting a story specification user interface on the display of the first end user processor-based device, the story specification user interface including at least one metadata specification field configured to allow a user to enter metadata for a story in the form of at least one of a title or a description of the story; a memorandum content field that displays user selectable content icons for each piece of content of the memorandum, a story board field configured to have a representation of user selected ones of the at least one piece of content displayed therein, and at least one set of user selectable content operation icons that are specific to the content type of the piece of content identified by the representation in the story board field, selection of which causes an operation to be performed on the piece of content. Presenting a story specification user interface on the display of the first end user processor-based device may include presenting the representation of the at least one user selected piece of content in the story board field in response to a user swiping motion on a touch-screen display of the first end user processor-based device, the user swiping motion moving from at least proximate the use selected content icon toward the story board field. When the content type is video presenting the at least one set of user selectable content operation icons may include presenting at least three user selectable icons the selection of which cause the piece of content to play, pause and stop, respectively. Presenting the story specification user interface may further include presenting at least one user selectable narration icon selection of which allows the user to record at least one of an audio or a video narration for the piece of content identified by the representation in the story board field and logically associate the recorded audio or the video narration with the piece of content. Presenting the story specification user interface may further include presenting a set of user selectable markup icons selection of which allows placement of graphic or textual indicator on a portion of the representation in the story board field. Presenting a set of user selectable markup icons may include presenting three user selectable icons the selection of which causes placement of text, an arrow, a circle, respectively, on a selected portion of the representation in the story board field. Presenting the story specification user interface may further include presenting at least one user selectable bookmarking icon selection of which allows the user to identify a portion of the piece of content identified by the representation in the story board field with a logical marker. Presenting the story specification user interface may further include presenting at least one field that displays each user selectable bookmark created by a user for the piece of content. The at least one content specification field may be configured to allow the user to specify the at least one piece of content for the memorandum by selecting an existing piece of content, recording or screen capturing a new piece of content and importing a new piece of content.

### BRIEF DESCRIPTION OF THE SEVERAL VIEWS OF THE DRAWINGS

FIG. 1 is a schematic diagram of a networked environment according to one illustrated embodiment, the networked environment including at least one client mobile computing device that provides an end user's user interface, optionally a client desktop computing device that provides an end user's user interface, and a server computing system communicatively coupled to the mobile computing device and a desktop computing device.

FIG. 2 is a data flow diagram of a server module according to one illustrated embodiment, the server module executable by the server computing system to provide services to the client mobile computing device and/or client desktop computing system.

FIG. 3A-3B is a flow diagram of a method of creating memorandums according to one illustrated embodiment.

FIG. 4A is a schematic diagram of a memorandum data structure according to one illustrated embodiment, the memorandum data structure may be stored in at least computer- or process-readable storage medium.

FIG. 4B is a schematic diagram of a content item data structure according to one illustrated embodiment, the content item data structure may be stored in at least computer- or process-readable storage medium.

FIG. 4C is a schematic diagram of a media object data structure according to one illustrated embodiment, the media object data structure may be stored in at least computer- or process-readable storage medium.

FIG. 4D is a schematic diagram of a story data structure according to one illustrated embodiment, the story data structure may be stored in at least computer- or process-readable storage medium.

FIG. 4E is a schematic diagram of a user screen annotation data structure according to one illustrated embodiment, the user screen annotation data structure may be stored in at least computer- or process-readable storage medium.

FIG. 4F is a schematic diagram of a user screen drawing data structure according to one illustrated embodiment, the user screen drawing data structure may be stored in at least computer- or process-readable storage medium.

FIG. 4G is a schematic diagram of a drawing conversion data structure according to one illustrated embodiment, the drawing conversion data structure may be stored in at least computer- or process-readable storage medium.

FIG. 5 is a flow diagram showing a method of adding content to a memorandum according to one illustrated embodiment.

FIG. 6 is a flow diagram showing a method of operating in a collaborative networked environment to interact with a story according to one illustrated embodiment.

FIG. 7 is a screen print showing a screen, panel or window of a user interface according to one illustrated embodiment, the screen, panel or window including a user interface displayable on a display of a client desktop computing system to allow an end user to add a story to a memorandum.

FIG. 8 is a screen print showing a screen, panel or window of a user interface according to one illustrated embodiment, the screen, panel or window including a user interface displayable on a touch screen of a client mobile computing device to allow an end user to add a story to a memorandum.

FIG. 9 is a screen print showing a screen, panel or window of a user interface according to one illustrated embodiment, the screen, panel or window including a user interface displayable on a display of a client desktop computing system to allow an end user to view and comment on a story.

FIG. 10 is a screen print showing a screen, panel or window of a user interface according to one illustrated embodiment, the screen, panel or window including a user interface displayable on a display of a client desktop computing system to allow an end user to reply a story.

FIG. 11 is a flow diagram showing a method of interacting with a database, according to one illustrated embodiment.

FIG. 12 is a flow diagram showing a method of interacting with a Web Service, according to one illustrated embodiment.

FIG. 13 is a flow diagram showing a method of transforming into XML Schema, according to one illustrated embodiment.

FIG. 14 is a flow diagram showing a method of transforming into meta data, according to one illustrated embodiment.

FIG. 15 is a flow diagram showing a method of performing validations, according to one illustrated embodiment.

FIG. 16 is a screen print showing a user interface according to one illustrated embodiment that allows a user to specify or customize connectivity behavior of a communications device.

### DETAILED DESCRIPTION

### System Components on Online Collaboration

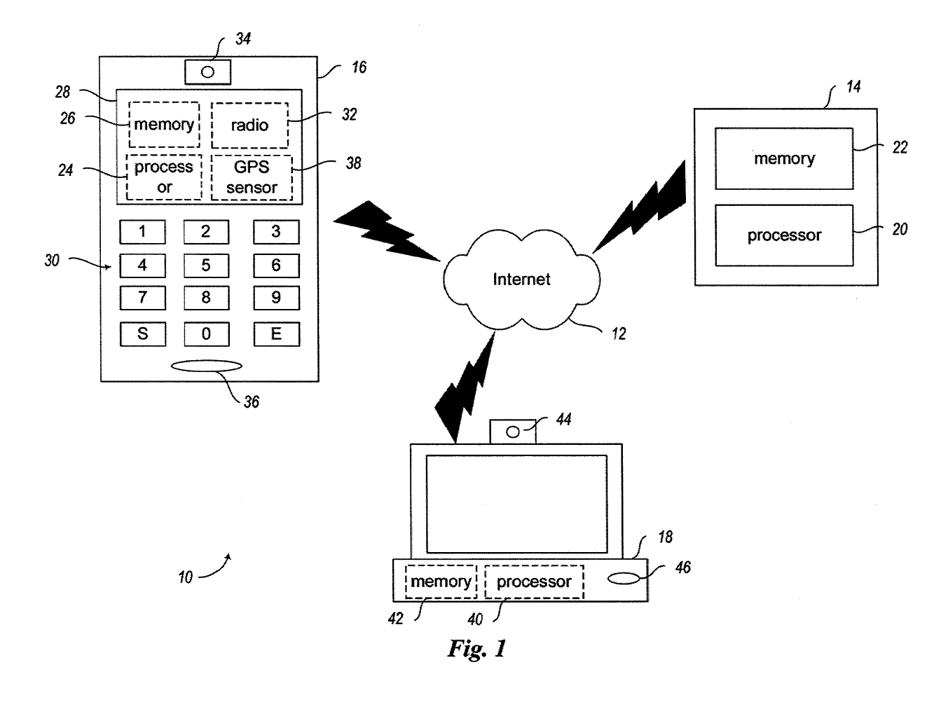

FIG. 1 shows an online collaboration environment 10, according to one illustrated embodiment. The online collaboration environment 10 includes a number of processor-based computing platforms which are communicatively coupled by one or more networks, for example the Internet 12. As illustrated, the online collaboration environment 10 includes one or more servers 14 (only one illustrated), one or more mobile computing devices 16 (only one illustrated) and optionally, one or more desktop computing systems 18 (only one illustrated).

The sever(s) 14 may take any of a variety of forms which include hardware such as one or more processors 20 (only one illustrated) and one or more computer- or processor-readable storage media 22 (only one illustrated) which stores instructions executable by the processor 20 to communicate with the client devices 16, 18, and to maintain certain databases or structures, as described herein.

The mobile computing devices 16 may take a variety of forms, for example smart phones, personal digital assistants (PDAs) and other portable processor-based systems. The mobile computing devices 16 include one or more processors 24 (only one illustrated) and one or more computer- or processor-readable storage media 26 (only one illustrated) which stores instructions (e.g., mobile computing client program) executable by the processor(s). While advantageously being mobile, such mobile computing devices 16 typically have displays (e.g., touch screen display) 28 with a limited screen size, as well as keyboard or keypads 30 with limited size. Mobile computing devices 16 may communicate wirelessly, for example via a radio 32 (e.g., transmit and receive in radio or microwave portions of the electromagnetic spectrum). Mobile computing devices 16 may additionally, or alternatively, communicate via optical signals and or may include one or more ports to provide for wired communications. The mobile computing device 16 may have one or more transducers or sensors to collect information or data, for example a camera 34, a microphone and/or speaker 36 and/or GPS receiver 38.

One or more smart phones or other connected mobile computing devices 16 (hereinafter referred to as the Mobile Computing Device or MCD) provide an ideal platform for collecting memorandum data for mobile professionals given its portability, availability of camera 34, microphone 36, GPS receiver 38 and other sensors and increasingly high processing and memory capabilities. In addition, the MCD 16 makes it possible for mobile professionals to have access to and be notified of any changes or alerts related to the collected memorandums in a collaborative context. The task of memorandum collection and editing is facilitated by a program running on the MCD 16. This program (hereinafter referred to as the Mobile Client Program or MCP) is typically a stand-alone client application developed for the MCD's native operating system using the appropriate software development kit (SDK) provided by the MCD's manufacturer. As an example an MCP may be developed using the Java programming language and using Research In Motion's (RIM) BlackBerry® Java® Development Environment (BlackBerry JDE). Alternatively the functions of the MCP may be provided by a Web Application developed specifically for this purpose. As an example, such a web application can be developed using Microsoft's C# and ASP.NET programming languages in the context of Microsoft Visual Studio Integrated Development Environment (IDE). Such a Web Application executes on the RIS and serves appropriate Web pages and application functionality through a Web Server to users using a mobile Web browser such as the Blackberry Internet Browser running on the Blackberry MCD.

Despite clear advantages of MCDs 16 as memorandum data collection and collaboration platform, these mobile computing devices 16 provide displays 28 having relatively limited screen real estate, user input means (e.g., keyboard 30) and limited data communication bandwidth. It is sometimes easier for mobile workers, especially when such workers return to the office or another location offering desktop or laptop computer systems 18, to collect, view and manipulate memorandum data using these computing systems 18. Furthermore, the home office staff or other workers with whom the given mobile worker is collaborating, tend to have ready access to desktop and laptop computer systems 18. Therefore a second component of the online collaboration environment 10 may comprise a desktop or laptop computer or work station 18 having one or more processors 40 (only one illustrated) and one or more computer-readable or processor-readable storage media 42 (only one illustrated that stores instructions (hereinafter referred to as the Client Program or CP) executable the processor(s) 40 that allow for online collaboration. The CP may be a program developed as a stand-alone desktop client to execute upon the native desktop operating system. As an example a CP may be developed using the Microsoft VB.NET programming language using the Microsoft Visual Studio Integrated Development Environment to execute upon the Microsoft Windows operating system. Alternatively the function of the CP may be provided by the same or similar Web Application described earlier in the discussion of the MCP. The user accesses this Web application via a standard Web browser running on the CSC such as the Microsoft Internet Explorer. The desktop or laptop computer or work station 18 may optionally include one or more transducers or sensors to collect information or data, for example a camera 44 and/or a microphone and/or speaker 46.

The above referenced processors may be any logic processor, such as one or more central processor units (CPUs), microprocessors, digital signal processors (DSPs), application-specific integrated circuits (ASICs), field programmable gate arrays (FPGAs), etc. Non-limiting examples of commercially available microprocessors include, but are not limited to, an 80×86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, a 68xxx series microprocessor from Motorola Corporation, or ATOM™ processor, commercially available from Intel Corporation.

The processor(s) and computer- or processor-readable storage media may be coupled by one or more system buses which can employ any known bus structures or architectures, including a memory bus with memory controller, a peripheral bus, and a local bus. A relatively high bandwidth bus architecture may be employed. For example, a PCI Express™ or PCIe™ bus architecture may be employed, rather than an ISA bus architecture. Some embodiments may employ separate buses for data, instructions and power.

The processor(s) and computer- or processor-readable storage media may include read-only memory (“ROM”) and/or random access memory (“RAM”). The memory may store a basic input/output system (“BIOS”), which contains basic routines that help transfer information between elements within the processor system, such as during start-up.

The processor(s) and computer- or processor-readable storage media may additionally or alternatively include a hard disk drive for reading from and writing to a hard disk, and an optical disk drive and/or a magnetic disk drive for reading from and writing to removable optical disks and/or magnetic disks, respectively. The optical disk can be a CD or a DVD, etc., while the magnetic disk can be a magnetic floppy disk or diskette. The hard disk drive, optical disk drive and magnetic disk drive communicate with the processor(s) via the system buses. The hard disk drive, optical disk drive and magnetic disk drive may include interfaces or controllers (not shown) coupled between such drives and the system buses, as is known by those skilled in the relevant art. The drives, and their associated computer- or processor-readable media, provide nonvolatile storage of computer-readable instructions, data structures, program modules and other data for the processor system. The processor system may other types of computer-readable media that can store data accessible by a computer may be employed, such as magnetic cassettes, flash memory cards, Bernoulli cartridges, RAMs, ROMs, smart cards, etc.

Program modules can be stored in the system memory, such as an operating system, one or more application programs, other programs or modules, drivers and program data.

For example, the system memory may also include communications programs, for example a server and/or a Web client or browser for permitting the processor system to access and exchange data with other systems such as user computing systems, Web sites on the Internet, corporate intranets, extranets, or other networks as described below. The communications programs in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While typically stored in the system memory, the operating system, application programs, other programs/modules, drivers, program data, server and/or browser can be stored on the hard disk of the hard disk drive, the optical disk of the optical disk drive and/or the magnetic disk of the magnetic disk drive. A user can enter commands and information into the processor system through input devices such as a touch screen or keyboard and/or a pointing device such as a mouse, thumb stick or trackball. Other input devices can include a microphone, joystick, game pad, tablet, scanner, biometric scanning device, etc. These and other input devices are connected to the processor(s) through an interface such as a universal serial bus (“USB”) interface that couples to the system bus, although other interfaces such as a parallel port, a game port or a wireless interface or a serial port may be used. A display is coupled to the system bus, for example, via a video interface, such as a video adapter. Although not shown, the processor system can include other output devices, such as speakers, printers, etc., as well as input devices such as cameras, microphones, GPS receivers, machine-readable symbol readers, radio frequency identification (RFID) interrogators, etc.

The processor system operates in a networked environment using one or more of the logical connections to communicate with one or more remote computers, servers and/or devices via one or more communications channels, for example, one or more networks. These logical connections may facilitate any known method of permitting computers to communicate, such as through one or more LANs and/or WANs, such as the Internet, intranet and/or extranet. Such networking environments are well known in wired and wireless enterprise-wide computer networks, intranets, extranets, and the Internet. Other embodiments include other types of communication networks including telecommunications networks, cellular networks, paging networks, and other mobile networks.

When used in a WAN networking environment, the processor system may include a modem for establishing communications over a WAN, for instance the Internet. Additionally or alternatively, another device, such as a network port, that is communicatively linked to the system bus, may be used for establishing communications over the network. Additionally or alternatively, the processor system may employ a radio (i.e., transmitter, receiver) for establishing communications.

In a networked environment, program modules, application programs, or data, or portions thereof, can be stored in a server computing system (not shown).

Those skilled in the relevant art will appreciate that the illustrated embodiments as well as other embodiments can be practiced with other computer or processor based system configurations, including handheld devices, multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processor based devices, which are linked through a communications network. In a distributed computing environment, program modules may be located in local and/or remote memory storage devices.

While some components will at times be referred to in the singular herein, such this is not intended to limit the embodiments to a single system or single components, since in certain embodiments, there will be more than one system or other networked computing device or multiple instances of any component involved. Unless described otherwise, the construction and operation of the various blocks shown in FIG. 1 are of conventional design. As a result, such blocks need not be described in further detail herein, as they will be understood by those skilled in the relevant art.

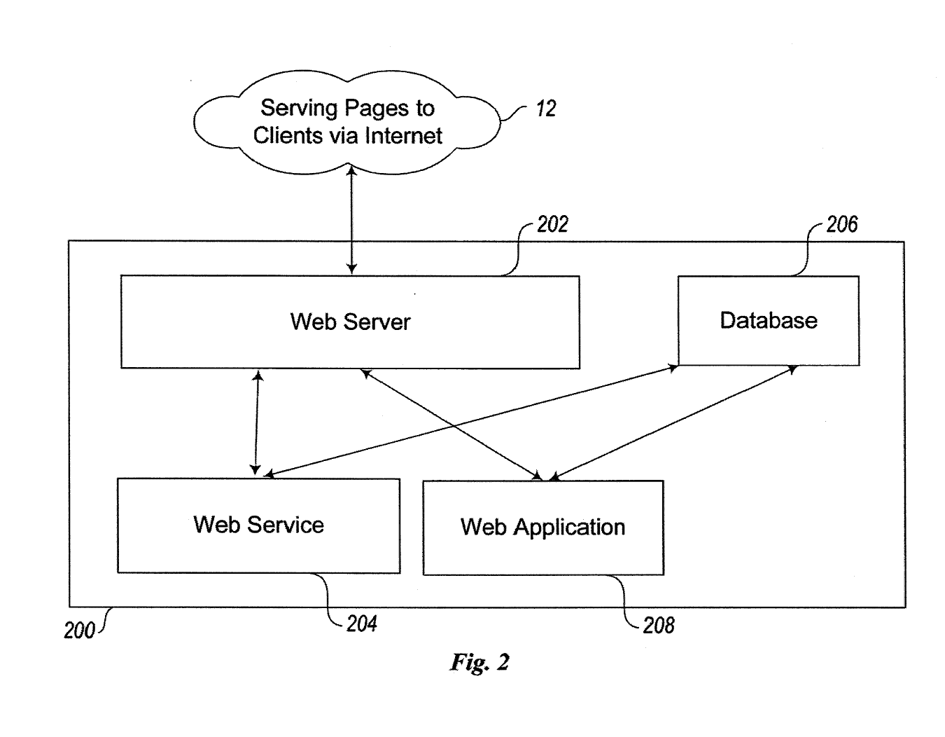

FIG. 2 shows a Server Module 200 (hereinafter SM) executing upon a Remote Internet connected Server (hereinafter RIS) 14 to provide data storage, access and synchronization services and system wide business rule enforcement. The SM itself is a collection of several software programs that carry out the above operations in concert with one another. One such program is the Web Server 202 which serves Web pages to clients that connect to the Web Server via the Internet 12. An example of a popular Web Server product is the Microsoft IIS® (Internet Information Services). Another useful program is the application's Web Service 204. The Web Service application is a set of instructions or program developed specifically to provide data access functions to the various data. The Web Service's 204 functions for sending and receiving data are provided to remote clients through the Web Server 202. When such functions are accessed by a remote program through the Web Server 202, the Web Service 204 connects to a Database 206 and handles the transactions required to access and update the records related to a memorandum, user and other system data. As an example, such a Web Service 204 may be developed using the C# programming language in the Microsoft Visual Studio Integrated Development Environment (IDE) and executes upon the Microsoft Windows Server operating system. The Web Service 204 typically uses the Structured Query Language (SQL) to communicate with the Database 206.

Another component of the SM is the Web Application 208. The Web Application 208 is set of instructions or program that is responsible for providing the application's functionality in the form of Web pages to remote users accessing the services through a Web browser and various databases. The Web Application 208 carries out data presentation, user input capture and program logic, as explained in more detail herein.

### Overview of System Operation

The systems and methods described herein enable mobile workers to not only efficiently collect multimedia memorandums but to also collaborate upon and resolve underlying issues or achieve entertainment or other benefits that are the subject of such memorandums. There are therefore at least three distinct activities that are facilitated. These include: collection, description and collaboration.

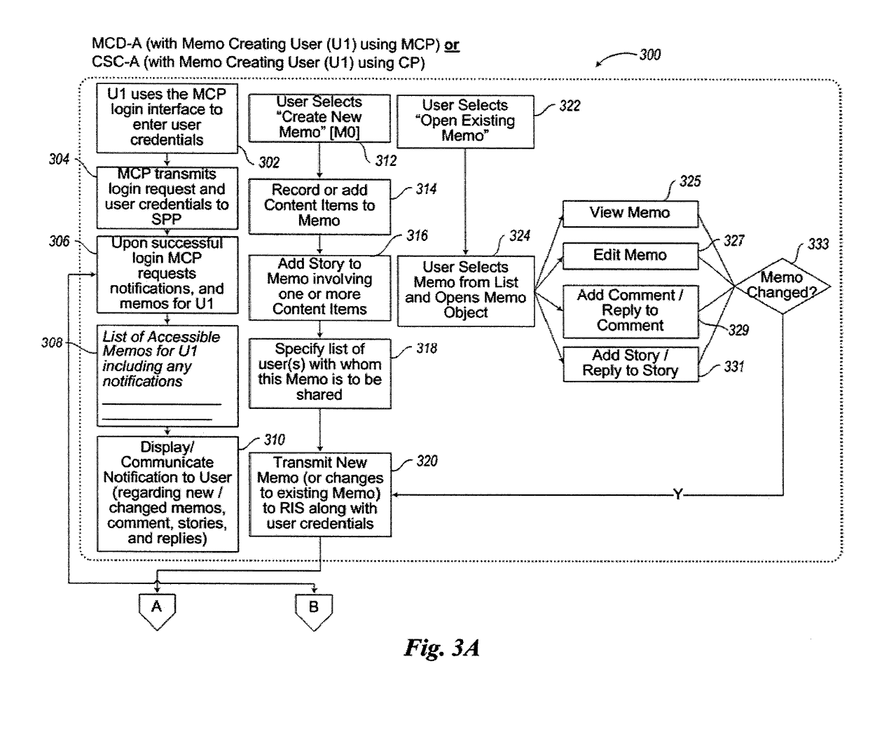

FIG. 3 shows a method 300 of operating one or more components of a networked collaborative environment, according to one illustrated embodiment.

At 302, operation typically begins with a Memo Creating/Editing User (U1) launching the MCP/CP and using user specific credentials to log into the system and establish a session with the SM at 304. At 306, the MCP/CP requests and receives a list of existing memorandums and notifications from the SM for the current user credentials. At 308 and 310, the user is presented with the choice of either creating a new memorandum or opening an existing memorandum. The user may select to create a new memorandum, at 312. New memorandum creation typically involves the addition of one or more Content Items such as images, audio or documents as well as other meta data such as title and description. At 314, the user records or adds content. Additionally, at 316 the user may add a story to memorandum involving one or more pieces of content. Such is described in more detail below. In addition the user typically specifies various sharing parameters for the given memorandum including list of people to whom access is to be granted and their respective rights and privileges, for example at shown at 318. At 320, the end user device may transmit a new memorandum to the RIS along with the user's credentials.

The user may also elect to open an existing memorandum from the list of memorandums available to that specific user, as illustrated at 322 and 324. In this case, depending on the user's access privileges, the user may be able to view 325 and possibly edit 327 the given memorandum, add a comment 329 or a story 331 to the memorandum. In either case (i.e., new memorandum created or existing memorandum opened) if any changes are made as determined at 333, the MCP/CP transmits such changes to the SM at 320, and the associated records in the SM database are updated accordingly at 322.

Upon receiving such data, the SM determines whether any notifications are to be sent to various users specified to have access to the memorandum at hand. Such notifications are typically sent to users to inform them of important changes such as changes made to the title, description or any media content in the memorandum or the addition or modification of comments or other annotations to a given memorandum as illustrated at 330 and 332. A typical mode of notification transmission takes place via sending of an email message with a short description of the change(s) made to the memorandum as well as an embedded Web link to guide the user to a Web page displaying the newly modified memorandum or specific change in the memorandum. Other modes of notification may employ use of a dynamic toolbar or status bar that appears in a prominent location on the user's desktop, browser tool bar area or other user interface screen, window or panel on the MCD or CSC. Such a status bar would for instance employ flashing or highlighted indicators to announce the arrival of a new notification. The user may then call up further details regarding such notification by identifying (e.g., hovering over with the cursor) or selecting (e.g., clicking upon the highlighted area) on the status bar.

As depicted in FIG. 3, a similar set of operations take place on the Collaborating User (U2) side. When this user launches the MCP/CP and logs into the SM using the user's credentials at 340, 342, a session is established. The MCP/CP requests notifications and memorandums intended for the Collaborating User (U2) at 344, such is transmitted to the user's device at 346 which presents the user (U2) with a list of memorandums to which the user has access at 348. Following along the current scenario, one such memorandum is that created by U1 earlier (M0). U2 may then proceed to open M0 at 350, 352 to view its Content Items and meta data at 354. U2 may also elect to edit the memorandum at 356, add a comment upon this memorandum at 358 or add a story to this memorandum at 360. In either case, if any changes are made by U2 upon M0 as determined at 362, such changes are again transmitted to the SM at 364 and the associated records in the database are updated and appropriate notifications are logged for the related users including U1.

As can be surmised from the foregoing high level description, the proposed architecture allows for incremental transmission and notification of the latest changes and feedback made upon each memorandum to users involved in a given subject or project. This mechanism enables mobile workers to initiate work on a subject (by collecting and logging a memorandum) and to collaborate upon the given subject (by making changes, adding comments, and replies to these) until the given subject is brought to a satisfactory conclusion or resolution as the case may be. The systems and methods also allow a given memorandum to be assigned to other individuals. The concept of assignment allows a memorandum creating user to transfer the responsibility of carrying a given memorandum to resolution or conclusion to someone else. Along with the ability to assign, a category/project label and a due date, the system allows memorandums to take on the form of tasks.

In addition to the aforementioned usage scenario which involves collaboration and coordination amongst mobile professionals, the systems and methods described herein may be used for other social interaction scenarios. As one such example, the systems and methods may be used to document, describe and/or share the details of a social event with family members or friends of the memorandum creating user.

### Data Structures

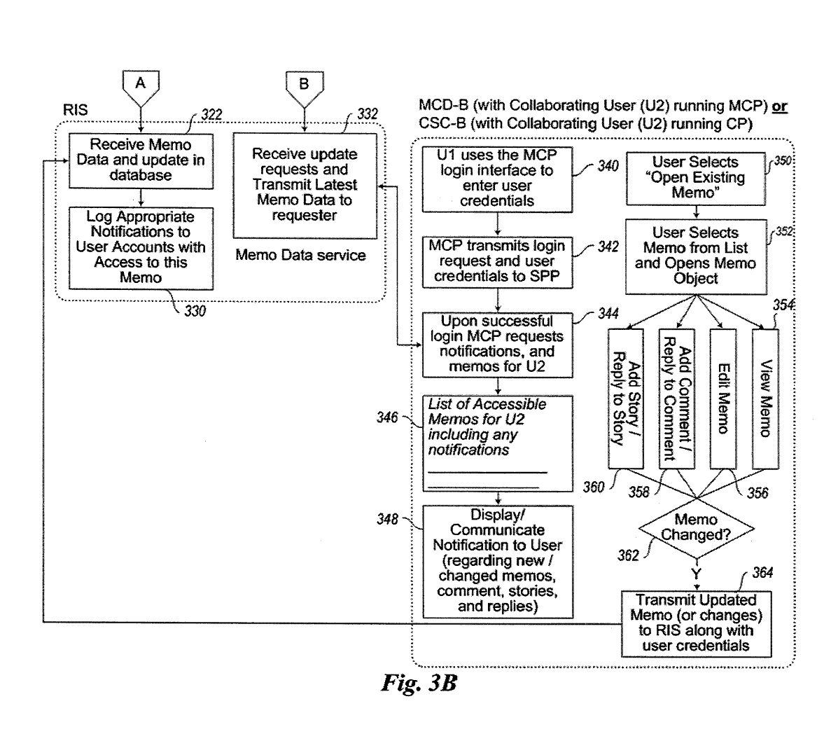

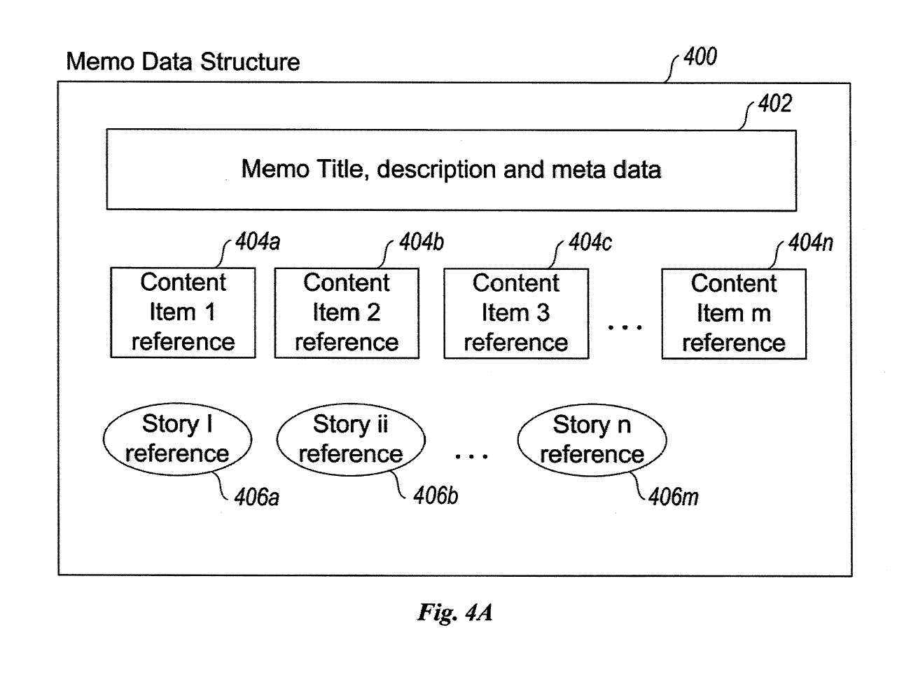

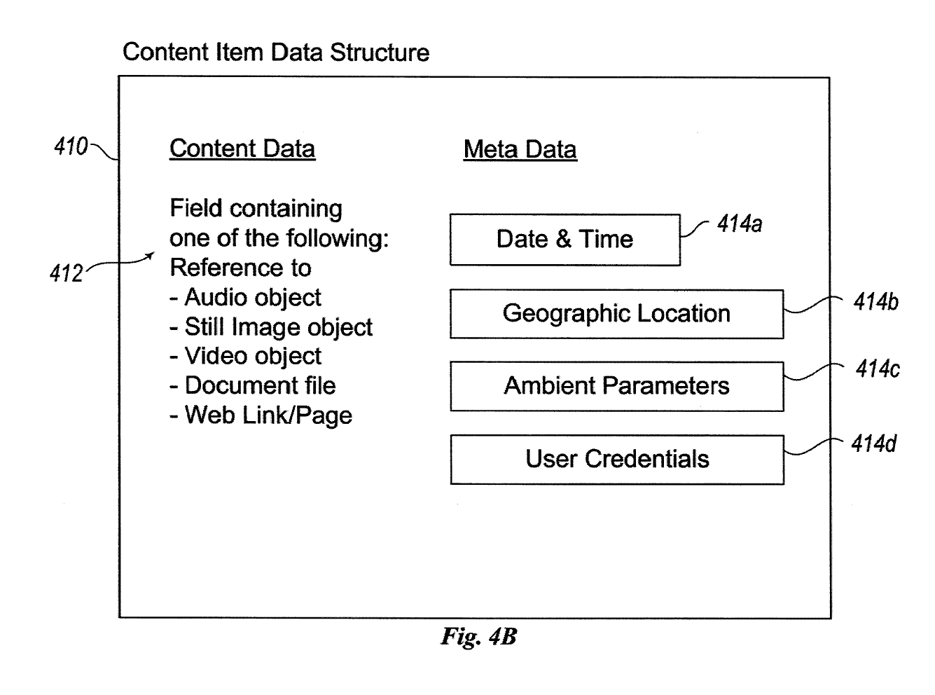

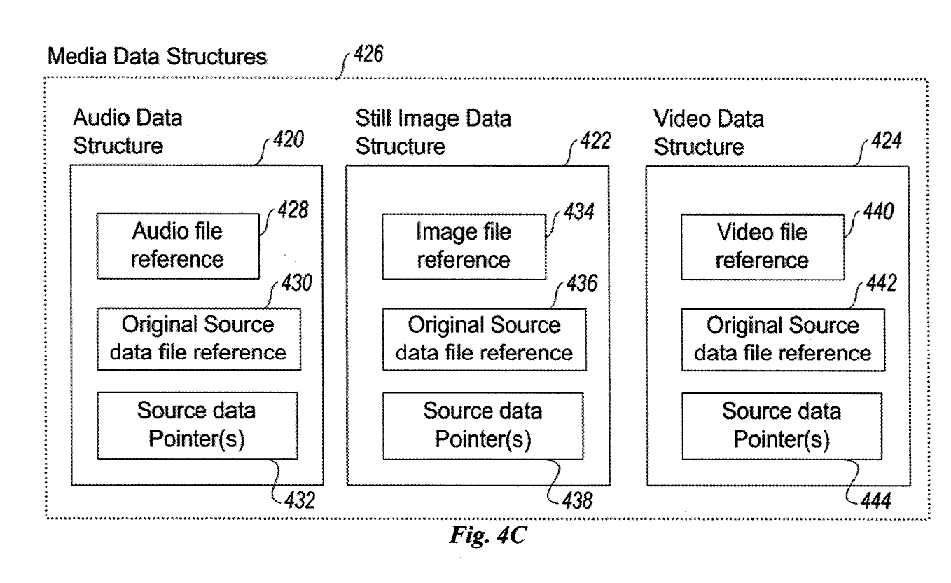

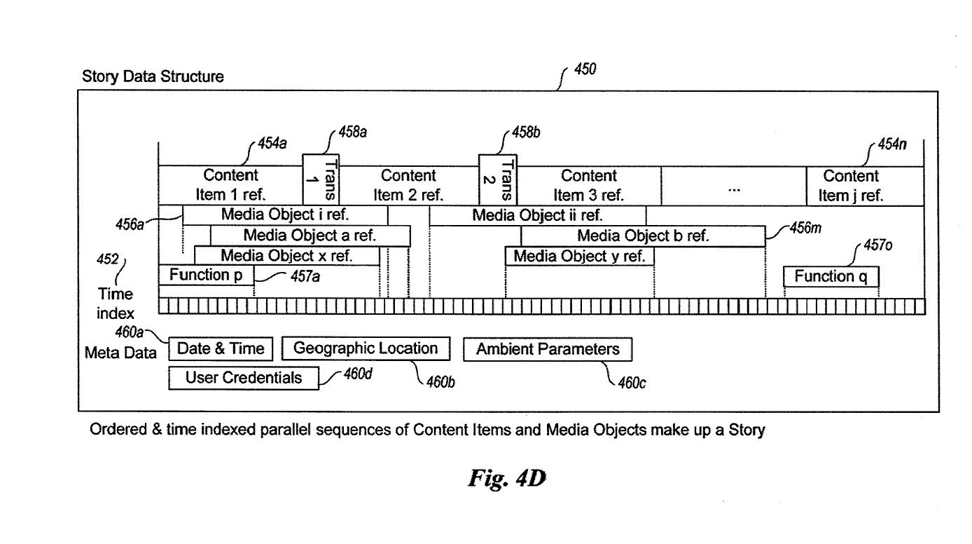

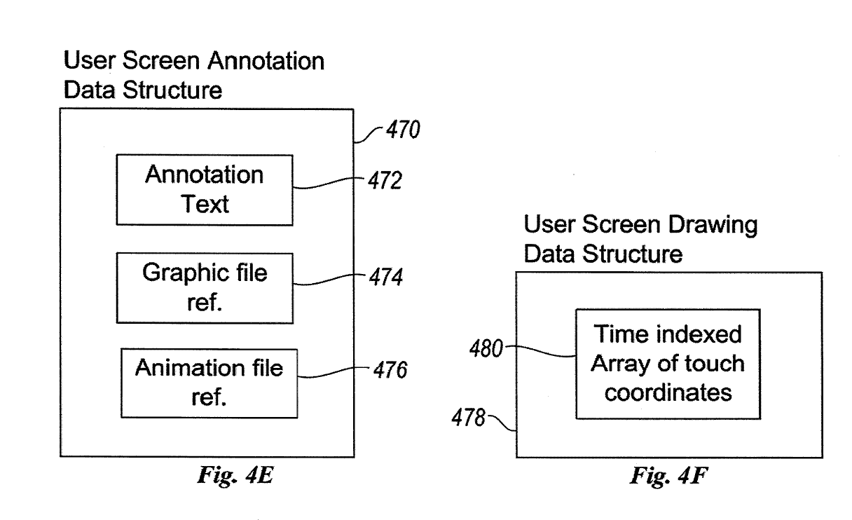

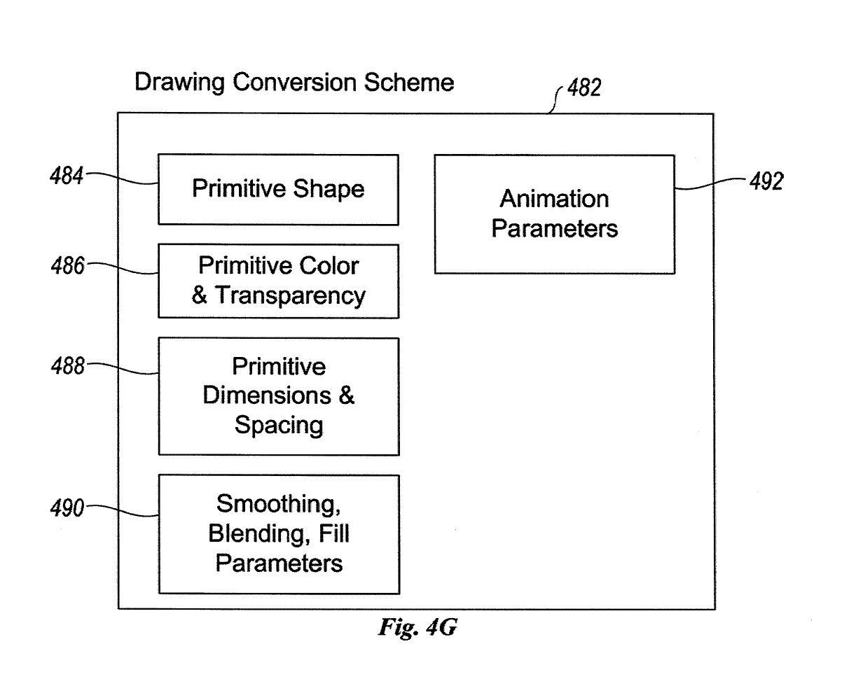

FIGS. 4A-4G show several underlying data structures according to one illustrated embodiment, which data structures may enable operation of the described systems and methods.

FIG. 4A shows a Memorandum data structure 400, according to one illustrated embodiment. The Memorandum data structure 400 is at the highest level of granularity, its role being to group all information related to a given memorandum or subject at hand. The Memorandum data structure 500 provides the advantage of maintaining the relationship between various, often heterogeneous data items related to a single subject. This characteristic eliminates the need for users to employ manual acts or secondary notes or documents to cross-reference and to maintain knowledge of relationships between various data items captured or recorded using disparate capture devices (e.g., keypad, keyboard, camera, microphone). As an example, a mobile worker may record text notes using a laptop computer, take several still images using a digital camera and record an audio memorandum describing the captured images. Applicants believe that conventional approaches do not employ explicit links or references that provide the relationship between the abovementioned data items as they relate to a particular subject or issue. The mobile worker is therefore required to mentally remember or to use another system to record the fact or existence of such relationships for future reference. In contrast, the Memorandum data structure 400 makes it possible to establish and maintain such relationships at the time of memorandum creation and throughout the lifecycle of a given memorandum. The Memorandum data structure 400 is composed of several fields such as meta data fields 402, as well as references to other related data structures namely one or more Content Item data structure(s) 404a-404n (collectively 404), and Story reference data structures(s) 406a-406m (collectively 406). The meta data fields 402 may, for example, include a memorandum title and description.

FIG. 4B shows a Content Item data structure 410, according to one illustrated embodiment. The Content Item data structure 410 is responsible for storing references to individual multimedia content data 412 or “pieces of content” including still images, audio recordings, video recordings, documents and Web pages, email documents. In addition to this main content data 412, the Content Item 410 also possesses a number of meta data fields 414a-414d (collectively 414) which provide details about the location, time and other parameters in force at the time of recording of the source data underlying the given content item.

It is worth noting that a still Image, audio, or video recording may have been derived from other underlying source data. For instance the original source of a still image may have been a page from a document that the user had previously added to a given memorandum. Similarly a video recording may have been created from a series of on-screen user drawings produced during the memorandum description process via an integrated or third-party drawing package or application. It is sometimes important to have access to such underlying source data for the purposes of modifying or enhancing the resultant image, audio or video data. For this reason, image, audio and video data are represented by dedicated data structures that maintain a reference to the original underlying data source as well as pointers to elements of such original data that were used to create the given image or video. As illustrated in FIG. 4C, these data structures include the Audio data structure 420, the Still Image data structure 422 and Video data structure 424 and as a group are referred to as Media data structures 426. The Audio data structure 420 includes an audio file reference field 428 that stores an audio file reference, original source data file reference field 430 that stores an original source data file reference, and one or more source data pointer fields 432 that store source data pointers. The Still Image data structure 422 includes an image file reference field 434 that stores an image file reference, original source data file reference field 436 that stores an original source data file reference, and one or more source data pointer fields 438 that store source data pointers. The Video data structure 424 includes a video file reference field 440 that stores a video file reference, original source data file reference field 442 that stores an original source data file reference, and one or more source data pointer fields 444 that store source data pointers.

FIG. 4D shows a Story data structure 450, according to one illustrated embodiment. The Story data structure 450 includes a time index 452 and holds the sequence and timing information that specify the playback order and duration of one or more parallel sequences of Content Items 454a, 454n (collectively 454, only two called out in FIG. 4D), Media Objects 456a, 456m (collectively 456, only two called out in FIG. 4D) and Processing Functions 457a, 457o (collectively 457, only two illustrated in FIG. 4D). The primary or base sequence consists of the Content Items 454 representing the media recorded as part of the memorandum creation process such as still images or video. Optionally, transition data structures 458a, 458b (collectively 458) define the duration and method of transitioning from one Content Item 454 to another. Additional sequences of Media Objects 456 represent recordings of user actions including video, audio, on-screen annotations and drawings whilst a Story is created. All Content Item, Media Object and Processing Function references included in the Story data structure 450 possess a start and end playing time index relative to a common Story playing time index 452. The Story data structure 450 also possesses a number of meta data fields 460a-460d (collectively 460) which define the details of location and time when a given Story was created.

FIG. 4E shows a User Screen Annotation data structure 470, according to one illustrated embodiment. The User Screen Annotation data structure 470 is specialized for storing specifics related to individual annotations placed upon the screen by the user. The User Screen Annotation data structure 470 has fields to store various annotations such as a text label annotation 472, reference to a graphic file 474 such as a vector drawing file and/or a reference to an animation file 476.

FIG. 4F shows a User Screen Drawing data structure 478, according to one illustrated embodiment. The User Screen Drawing data structure 478 is used to store a time-indexed array of screen coordinates 480 traversed by the user as a gesture or drawing is produced on the touch screen display, tablet, touch pad, or similar device. Alternatively, a cursor control or pointer device may be employed, for instance, with a display that is not touch sensitive. This data can be used to produce on-screen overlays or animations that clearly communicate the intent of the user drawing/gesture. For instance one can establish that each pair of coordinates is to result in drawing of a graphical dash, 5 pixels in length, with the color yellow and with transparency level set to 70%.

The result of applying the abovementioned example, Drawing Conversion Scheme 482 (FIG. 4G) to the user drawing data is an overlay that graphically depicts the path traced by the user on the screen but does not fully block the background image. The parameters for drawing conversion can be adjusted to produce the desired effect for a given class of drawings/gestures. Additionally, the proper Drawing Conversion Scheme may automatically be selected by the system based on an identification of the underlying drawing/gesture type. Thus, the Drawing Conversion Scheme 482 may include primitive shapes 484, primitive color and transparency 486, primitive dimensions and spacing 488, smoothing, blending and fill parameters 490, as well as animation parameters 492.

### Adding Content to a Memorandum

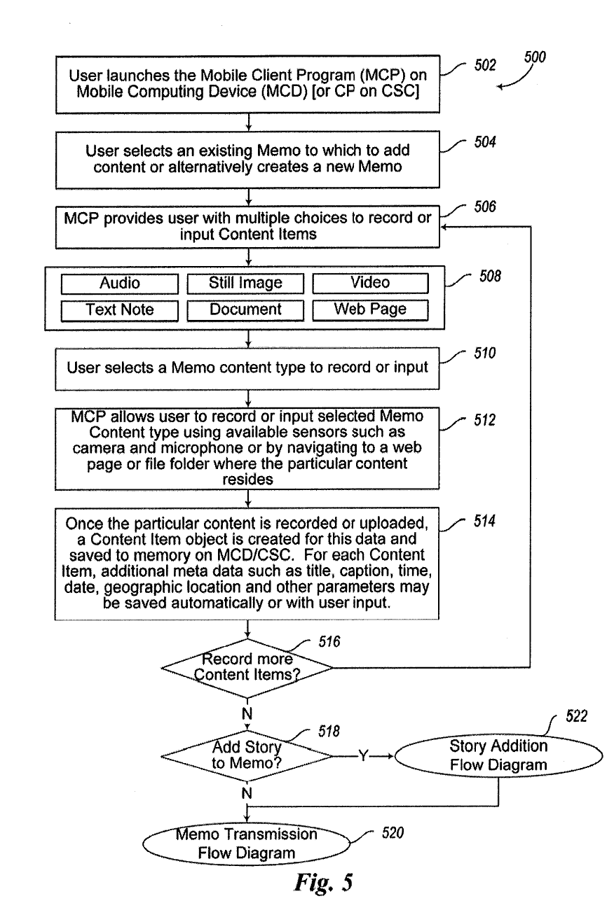

FIG. 5 shows a method 500 of operating in a networked collaborative environment, according to one illustrated embodiment.

At 502, a user creates a memorandum by launching the Mobile Client Program (MCP) on the Mobile Computing Device (MCD) or the Client Program (CP) on the Client Station Computer (CSC). The respective program provides the user with a choice of opening an existing memorandum or creating a new memorandum. At 504, the user selects an existing memorandum to add content to, or selects to create a new memorandum. In either case, at 506 the user is provided with various choices 508 for recording or alternatively inputting various forms of content including audio, still images, video and text. As an example, the user may elect to record a video clip of the environment using the MCD's integrated camera. Additionally the user may add some text notes and attach a PDF document and reference to an online video (as a web link) to the memorandum being created. When the user instructs the system to create a new memorandum, the system responds by creating a memorandum object (based on the Memorandum data structure). For each new data item added, the system creates a Content Item object and stores a reference to this object in the memorandum object.

At 510, the user selects a memorandum content type to record or input. At 512, the MCP allows the user to record or input selected memorandum content type using available sensors such as a camera and/or microphone or other sensor or detector, or by navigating to a Web page, file folder or other user interface screen accessible on the device where the particular content is stored. At 514, a Content Item object is created for the data and saved to memory on the MCD/CSC. Various meta data may be saved for each Content item, for example title, caption, time, date, geographic location, or other parameters. Such may be automatic or may be entered by the user. At 516, the method 500 determines whether there are additional Content items, returning to 506 if there are additional Content items. Otherwise, control passes to 518, where the method determines whether the user wishes to add a story to the memorandum. If so, control passes to a story addition method at 522. If not, control passes to a memorandum transmission method at 520.

The novel approach described herein provides the ability to integrate multiple media types into a cohesive memorandum object focused on describing a given subject or situation immediately at the source. In contrast, conventional data collection and note taking systems focus on gathering single type of media such as an image, a voice note or a text note. The user of such conventional systems is then burdened with the task of manually integrating said media into a unifying container such as an email message or issue object.

### Receiving a Memorandum & Providing Feedback

Once an Originating User creates a memorandum and adds content to it, the originating user can share the memorandum with others by specifying the email addresses or other electronic contact information of those with whom the memorandum should be shared. Upon receiving notification(s), the Receiving User(s) may navigate to the memorandum by requesting and browsing one or more Web pages served by the SM or by opening and launching the instances of MCP/CP executing on the user's computing device. Each user is then presented with a list of memorandums to which that user has been granted access and proceeds to open the newly added memorandum. The user can navigate the various sections or tabs or menus displayed for the current memorandum. Each tab may, for example present a different type of Content Item such as audio, still pictures and video. Alternatively, all Content Items may be placed onto one user screen or tab in order to provide the user with an overall view of the subject at hand. The user interface provides the ability for users to provide direct, multimedia feedback and opinion on the Content Items of a given memorandum. For each Content Item, the user is presented with a Comment user control such as a button. The user has the choice of leaving a comment in any number of forms including simple text, audio or video. As an example, a receiving user may view a still picture Content Item of a memorandum related to a graduation or other social event and decide to leave a personal/expressive video message of congratulations. The user can do so by pressing the Comment button, choosing the video option and recording a short clip using the camera on-board his smart phone (MCD) or laptop computer (CSC). Such user comments are logged by the system into the database as part of the memorandum object and the relationship between the comment and the given Content Item is preserved. Another section/tab or menu of a user interface associated with presentation and/or interaction with the memorandum object presents users with the list of comments received for a given memorandum. All comments including their link to a given Content Item are displayed in this area. Users can choose to create new general comments, new comments on specific Content Items or comments as replies to existing comments. In this fashion, the user interface and the memorandum object facilitates collaboration upon the subject or situation at hand in both the simple, traditional text-based manner as well as the novel multimedia method described above. The multimedia method provides multiple advantages over the traditional method including speed and efficiency (especially in situations when typing is difficult) as well as significantly higher information richness by conveying voice color and body language that is absent from text-based communication.

### Creating a Story

The system and method described herein advantageously allow users to create and transmit Stories and to view and comment upon Stories created by other users. While the memorandum creation, subsequent data recording and transmission capabilities of the system provide users with the highly valuable facility to have common access to a cohesive set of content describing a given subject, for the most part such data lacks explicit description of relationships and context. There is therefore a need to establish and demonstrate such relationships, explain nuances and emphasize certain aspects of the base memorandum data in order to better communicate the subject or situation underlying the memorandum. The creation, transmission and discussion of such descriptive information is accomplished by creating a Story and sharing this with other collaborating users. The collaborating users in turn can respond by creating and sharing their own stories and so forth. The Story creation and reply mechanism enable geographically and temporally disparate users to be informed and to discuss the details of a subject in a natural manner similar to an in-person meeting.

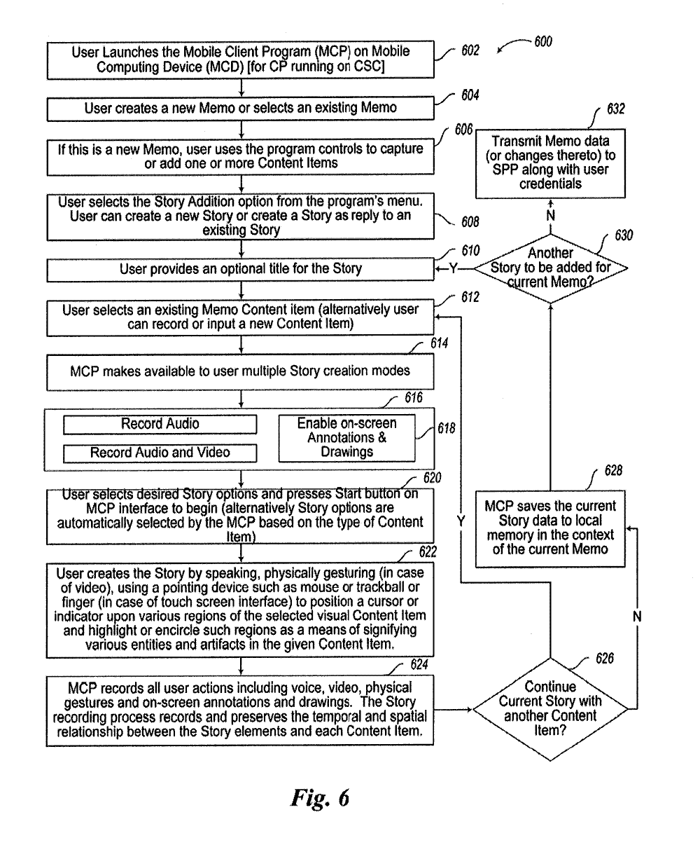

FIG. 6 shows a method 600 of operating an online collaboration system to create stories, according to one illustrated embodiment.

The method 600 starts at 602, for example when a use launches the mobile computing program (MCP) on the user's mobile computing device (MCD). At 602, the user creates a new memorandum or selects an existing memorandum from a list of memorandums to which the user has access. At 606, if a new memorandum, the user uses the program controls to capture or add one or more pieces of content or Content Items.

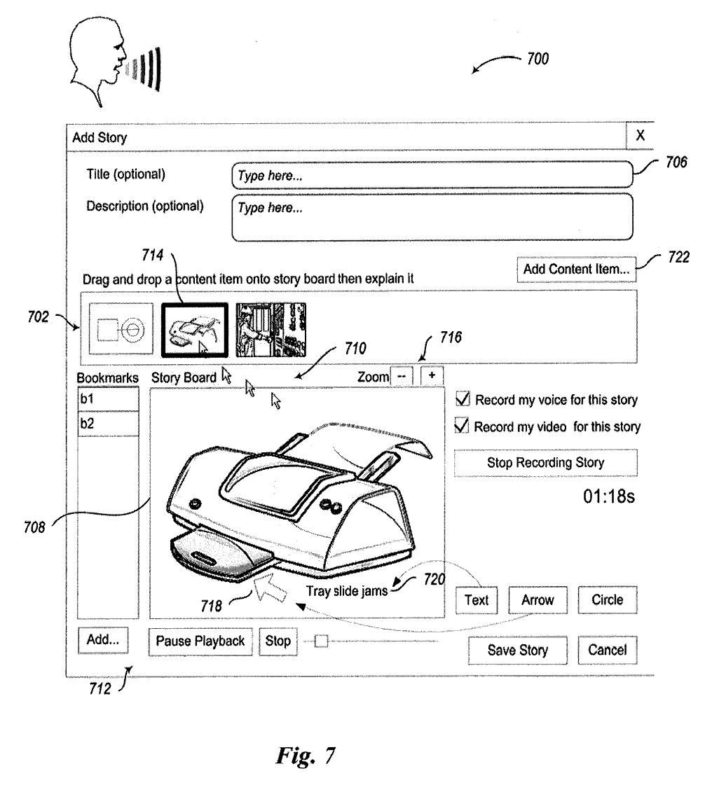

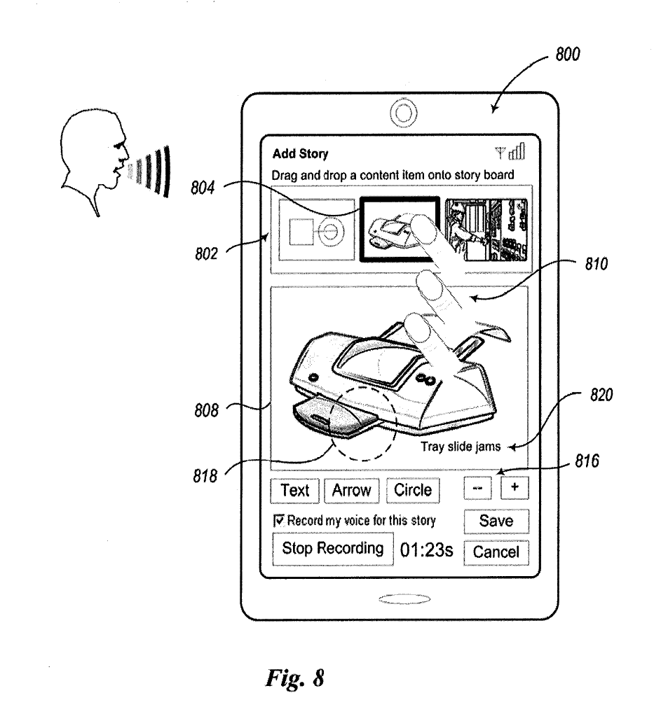

The Story creation process begins when the user calls up the Story Creation option at 608 from the context of a given memorandum from the MCP/CP interface as depicted in FIGS. 7 and 8. This screen 700, 800 provides the user with a menu of Content Items 702, 802 previously collected or added for the given memorandum shown in the form of a visual film strip-like presentation of images or other visually clear and convenient means depicting a series of thumbnail views. Content Items 704, 804 (only one called out in each of FIGS. 7 and 8) displayed in this area typically include still images, video recordings, screen captures as still images or video recordings, Web pages as well as optionally previously recorded Stories. The user optionally provides a title in title field 706 for the story at 610. The user selects an existing Content Item 704, 804 or records or inputs new Content at 612. The interface enables the user to select a Content Item 704, 804 from a film strip-like presentation 702, 802 and drag and drop this item onto another area of called the Story Board 708, 808. This is illustrated in FIG. 7 by the successive positions of a cursor 710, and in FIG. 8 by the successive positions of the user's finger 810. The Story Board 708, 808 is the viewing and manipulation area for various Content Items 704, 804 as the Story recording process takes place.

Depending on the type of Content Item dropped onto the Story Board area, at 614, 616 the software causes the display of a set of appropriate playback and navigation controls 712, 812 in the action area below the Story Board. For instance, if the current Content Item 704, 804 is a video recording, the system displays a Play button as well as a slider control below the Story Board 708, 808 showing the current playback position and enabling the user to advance or rewind the video as needed. The user can employ these controls to navigate and review a given Content Item 704, 804 before and during the Story recording process. The user may elect to record audio including speech, audio and/or video during the Story recording process. These options are configured via on-screen controls. When user is ready to begin the Story recording process, the user proceeds by dragging and dropping the first Content Item 704, 804 onto the Story Board 708, 808, if the user has not already done so. At 620, the user then presses the Start Recording button and begins to describe the current Content Item. At 622, the user may proceed along the natural path of explanation for the situation or subject underlying the given memorandum similar to an in-person meeting. This is accomplished in several ways. As mentioned above the user first selects a given Content Item 704, 804 thus bringing the given Content Item to the center of attention of those viewing the Story at a later time. The user then continues to develop the Story by speaking, pointing and clicking the screen (or touching the screen in the case of a touch screen interface) to signify a given region in the current Content Item that is of significance to the subject at hand. The user may also invoke various processing functions upon the Content Item as appropriate. For instance, in the case of a still image, the user may first invoke a zoom-in function using appropriate icons 716, 816 followed by a sharpening function in order to improve the visibility of any specific detail that the user is interested in describing in the course of the Story. Other processing functions may be employed that enable the user to automatically detect, identify and highlight important detail in the given Content Item such as automated detection and recognition of faces or patterns. The user may also place an informational graphic, such as an arrow 718, or an animation, such as a flashing warning symbol, marqueeing, etc., a circle 818 as well as text labels 720, 820 onto the current Content Item to further describe and draw attention to its various aspects.

As the user proceeds with developing the Story, at 624 the system records all user commands and processing functions invoked including Content Item selection, playback, rewind, forward, pause, playback speed control, volume control and other functions and their associated timing and parameters are saved as raw data records into memory. The system also records the audio and video input provided by the user and saves these in the form of individual audio and video files or other convenient data format dictated by the underlying device. Static on-screen annotations such as graphic icons or symbols are typically recorded as individual still image files. On-screen drawings or animations may be stored as individual video files consisting of a sequence of overlay transparency frames. Finally, any document pages, Web pages or other user screens selected for display on the Story Board during the Story recording process are typically digitally scanned via the software from their original source and saved as individual still images or video recordings. For each of the above recorded audio, still image and video files, an Audio, Still Image or Video data object is created (generally referred to as a Media Object) based on the Media Data Structure. Each such object maintains a reference to the data file (e.g., image file), a reference to the original source data file (e.g., document file from which the image may have been created) and pointer(s) to desired locations in memory within such original source data (e.g., document page number from which the image is created).

At 626, the system determines whether the user wishes to continue the current story with another Content Item, for example in response to a user selection of an appropriate icon 722. If so, control returns to 612. Otherwise, control passes to 628.

At 628, the MCP saves the current Story data to a local memory in the context of the current memorandum. At 630, the system determines whether the user wishes to add another story for the current memorandum. If so, control passes to 610. Otherwise, control passes to 632 where the MCP transmits the memorandum data or changes thereto to the SM along with the user's credentials for updating the data base(s). In order to save the Story, the system creates the Story object by storing, in a precisely time-indexed manner, references to the sequence of Content Item objects selected by the user and placed onto the Story Board during the Story, the beginning and end indices of each Content Item's display period(s), any functions invoked against such Content Item and associated timing and parameters, references to the Media objects containing the audio and video input provided by the user and their associated timing and parameters, and finally references to any Media objects containing the various on-screen annotations, animations or drawings created or added during the Story recording process and their associated timing and parameters. The above information is stored in the Story data structure so as to specify a series of parallel, time-indexed sequences of references to Content Items, Media Objects and Processing Functions.

The information stored in the Story object is later used by the system to play back the given Story according to the precise sequence and timing used by the user creating the Story in the first place.

It is evident that the recording and storage of Story information can take place in many different ways and that the preceding description is only one way to carry out these objectives.

### Transmission, Viewing and Collaboration on a Story

Once a Story has been created in the context of a given memorandum and the Creating User presses the Save button on the Story Addition interface, MCP/CP responds by saving the Story object and all underlying data as part of the corresponding memorandum object data. Typically the memorandum data is first saved to local memory on the MCD or CSC and subsequently serialized and transmitted to the RIS at the next available communications or connection opportunity. In this fashion, the updated memorandum data is received by the SM whereby appropriate records are created and stored in the database that resides on the RIS. When a new memorandum or updated memorandum is received by the SM, the program examines changes made to the memorandum data. If changes are deemed significant in light of specified business rules and user preferences and if the memorandum has been specified to be shared with other users, the SM sends appropriate notifications to these Collaborating Users.

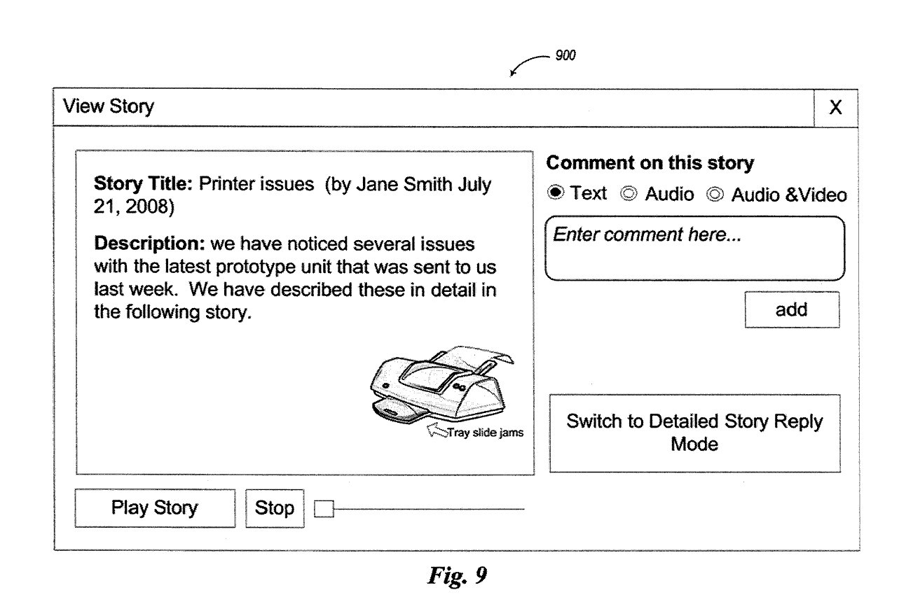

The addition of a Story to a memorandum is typically considered a significant change and as such, the SM sends notifications to the list of Collaborating Users. Once these users receive such notifications, they may access the modified memorandum via a Web browser or alternatively through their installed instances of MCP/CP. When Collaborating Users open the modified memorandum object, they can navigate to the list of Stories for this memorandum and open the new Story created earlier by the Creating User. By default, the Story opens inside a Story Viewer interface 900 depicted in FIG. 9. The Story Viewer allows a user to play back the Story in a manner similar to how a digital video recording is played back.

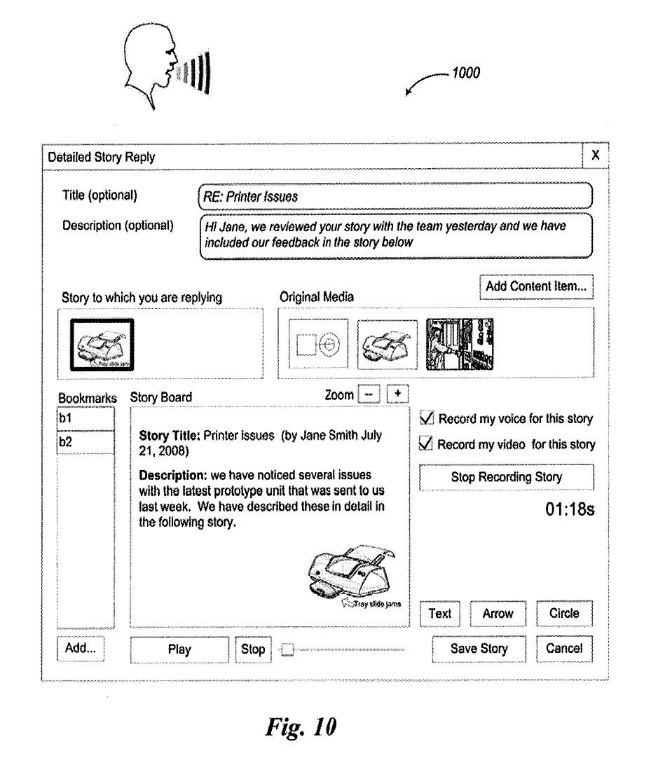

As the user plays back the story, all Creating User actions including Content Item selections, audio, video and on-screen annotations and drawings are played back in their original form as recorded and specified during the Story recording process described earlier. The viewing user can pause or stop the play back operation at any time using the provided controls. The Viewer Interface also provides the user with a facility to comment on the Story being viewed. The user can type their comments as text or alternatively record an audio or video comment on the current Story by using the appropriate controls. In cases whereby the user wishes to provide a more detailed reply or to comment on specific elements of the original Story, the user may switch to the Detailed Story Reply Mode by pressing the corresponding button from the Story Viewer interface 1000 (depicted in FIG. 10).

MCP/CP responds by opening a different interface which is in essence very similar to the Story Addition interface. The Detailed Story Reply interface provides the user with a Story Board and pre-loads the original Story onto this board. The interface also provides the user with a film strip-like menu of the media upon which the original Story was based. In this fashion, the Collaborating User may reply to the original Story by creating a new Story based on the original Content Items (e.g., media) as well as the original Story. In addition, the Collaborating User may similarly add or record additional Content items and use these in the Story being created. In doing so, the Collaborating User follows a similar workflow to the one used by the original user who created the Story. Once the Collaborating User has completed developing the reply Story, the user presses the Save button on the interface. MCP/CP responds by saving the Story object in the context of the memorandum object data and transmits the modified memorandum object to the SM at first available connection opportunity. Upon receiving the modified memorandum data, the SM executes a similar notification process to the one described earlier. The end result is that the Collaborating Users are notified of the Reply Story and can return to view, comment upon or provide a detailed reply to this Story.

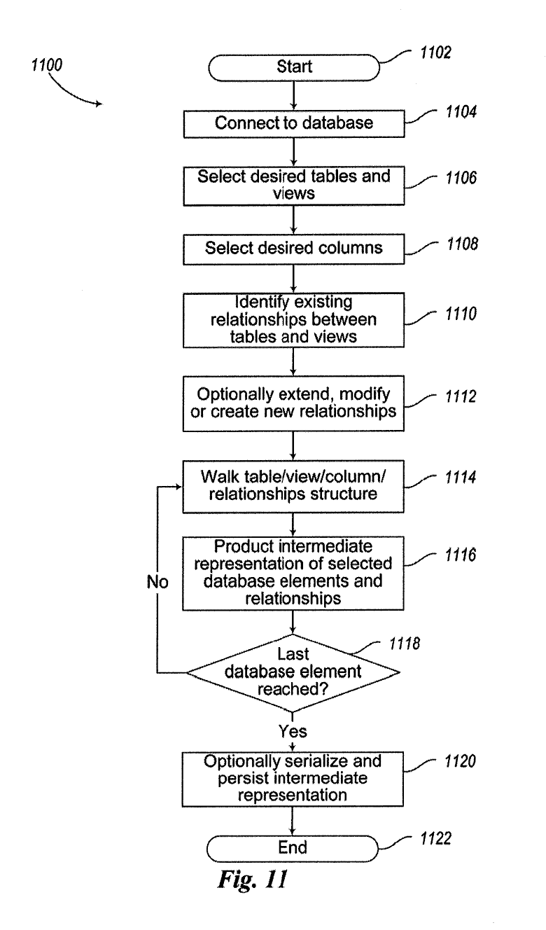

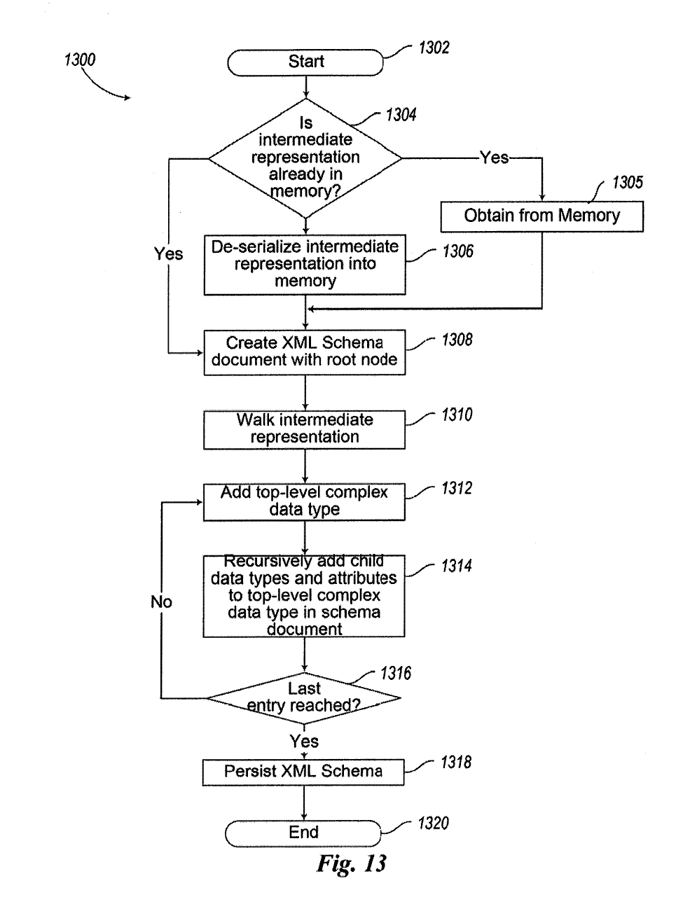

FIG. 11 shows a method 1100 of interacting with a database, according to one illustrated embodiment. The method 1100 starts at 1102. Coming from a relational database, enough information is captured to first establish a connection to that database at 1104. The tool reads the database catalog to present the user with the available tables and views. The user selects the appropriate tables and views that represent the data the user wishes to make available via this tool at 1106. Optionally, the columns from the selected tables and views can be filtered to only what is desired to be in the ultimate schema at 1108. The tool extracts the database's existing primary and candidate keys, foreign keys, and relationships, to begin to understand how the selected data relates to each other at 1110. The user can then add, edit or delete relationships that express how they want the schema to be constructed at 1112. All of the information and options selected in the previous acts feed into the extraction of that information into the intermediate format at 1114, 1116, 1118. This format can optionally be serialized for later use at 1120 or used immediately in the creation of the desire outputs (see FIGS. 13, 14 and 15). The method 1100 may terminate at 1122. Alternatively, the method 1100 may repeat, for example as a continuous thread executed by a multi-threaded processor.

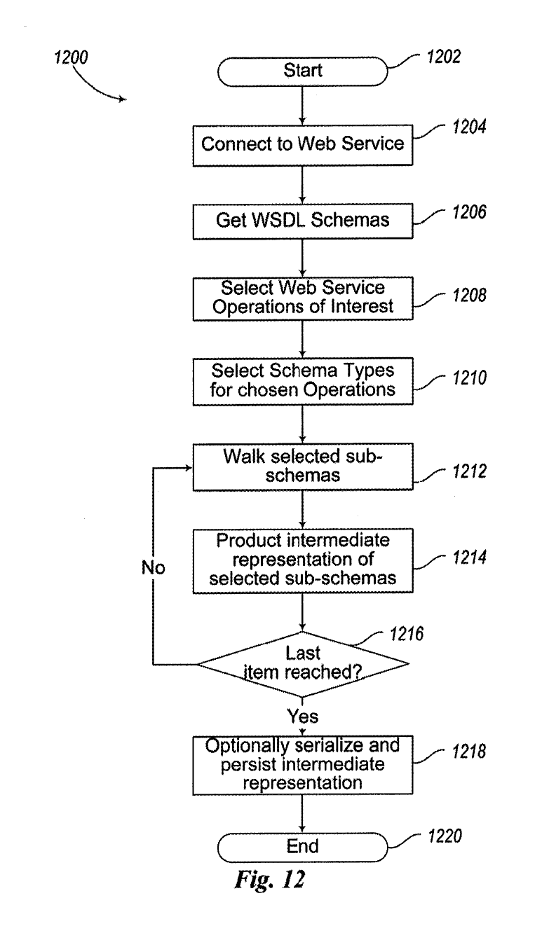

FIG. 12 shows a method 1200 of interacting with a Web Service, according to one illustrated embodiment. The method 1200 starts at 1202. If the source of the desired schema is from a Web Service, the user specifies the endpoint of that service and a connection is established at 1204. The initial schema is obtained from the WSDL at 1206. The user then selects the operation(s) of interest at 1208 and associates schema types for those operations at 1210. Each selected item is processed into the intermediate format at 1212, 1214, 1216. This format can optionally be serialized for later use at 1218 or used immediately in the creation of the desired outputs (see FIGS. 13, 14 and 15). The method 1200 terminates at 1220. Alternatively, the method 1200 may repeat, for example as a continuous thread executed by a multi-threaded processor.

FIG. 13 shows a method 1300 of transforming into XML Schema, according to one illustrated embodiment. The method 1300 starts at 1302. To create the XML Schema, the systems determines if such is available from memory at 1304. The intermediate format is obtained either from memory at 1305 or from a previously serialized file at 1306. Using the intermediate format and the transformation process, the creation of the XML Schema starts with the root note at 1308. Children of the root node are located in the intermediate structures at 1310, 1312 and the captured child-parent relationships are recursively executed at 1314 until no node contains any unrepresented children at 1316. The XML Schema is persisted for use by the later processes at 1318. The method 1300 terminates at 1320. Alternatively, the method 1300 may repeat, for example as a continuous thread executed by a multi-threaded processor.

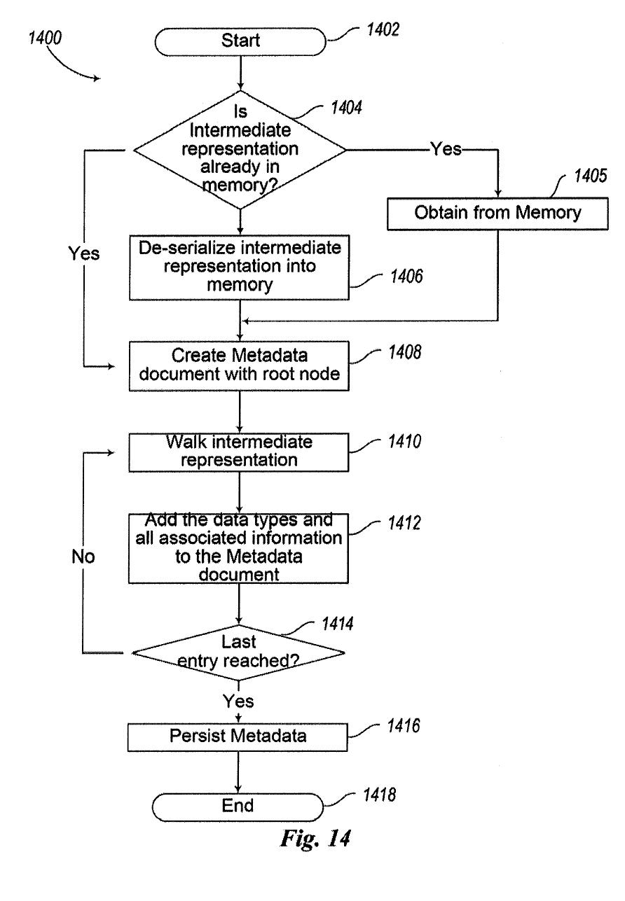

FIG. 14 shows a method 1400 of transforming into meta data, according to one illustrated embodiment. The method 1400 starts at 1402. To create the associated Meta Data, the system determines of an intermediate format representative is available in memory at 1404. If available, the intermediate format is obtained from memory at 1405, or otherwise is obtained from a previously serialized file at 1406. Using the intermediate format and the transformation process, the creation of Meta Data starts with the root node at 1408. All captured elements are processed at 1410 and their attributes, relationships and other constraints are written to the Meta Data document at 1412 until there are no more elements to process at 1414. The Meta Data is persisted for use by the later processes at 1416. The method 1400 terminates at 1418. Alternatively, the method 1400 may repeat, for example as a continuous thread executed by a multi-threaded processor.

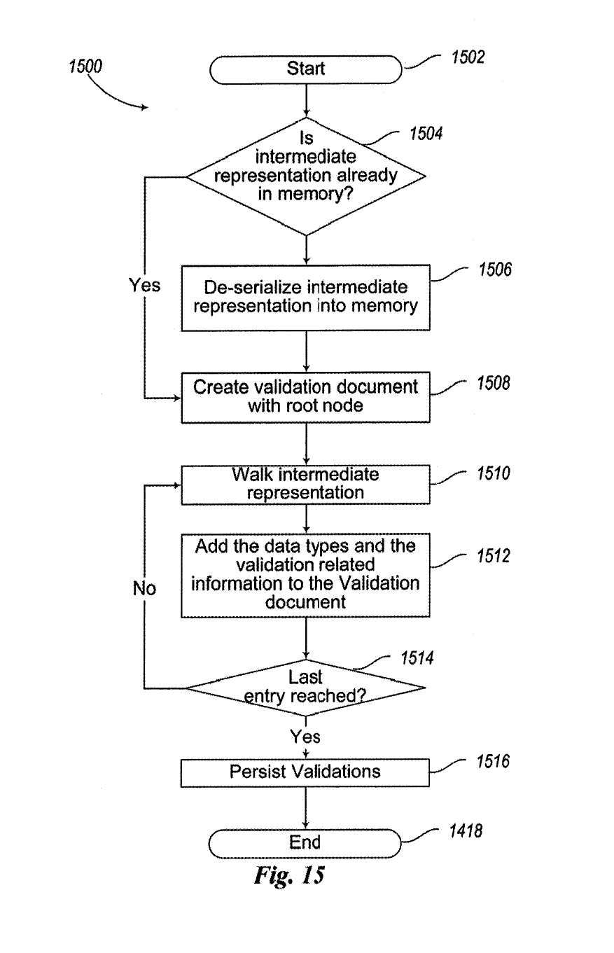

FIG. 15 shows a method 1500 of performing validations, according to one illustrated embodiment. The method 1500 to create the associated Validation information starts at 1502. At 1504, the system determines whether an intermediate format representation is available in memory. If available, the intermediate format is obtained from memory at 1505. Otherwise, the intermediate format representation is obtained from a previously serialized file at 1506. Using the intermediate format and the transformation process, the creation of the Validation document starts with the root node at 1508. All elements are processed at 1510 and their previously captured validation information is written to the Validation document at 1512 until there are no more elements to process at 1514. The Validation document is persisted for use by the later processes at 1516. The method 1500 terminates at 1518. Alternatively, the method 1500 may repeat, for example, running continuously or periodically as a separate thread from other methods or processes, or being called by selected methods or processes.

### Additional Aspects of Invention

Integration with Secondary Systems

In a typical embodiment, when a new memorandum is created or when an existing memorandum is modified, the MCP transmits the memorandum object data to the RIS by connecting to the SM. The SM then proceeds to update the appropriate records and files residing in the database for the given memorandum. In some instances, a given user may be accustomed to or be required to use an existing issue tracking, project management, social networking or other workflow management system to carry out the user's daily tasks or to communicate with others. In such cases, it is beneficial for described system to communicatively connect with such third party systems in order to provide user access to memorandum data from within secondary systems. One way to accomplish such communicative connection is made possible by Web Services Technology which enables machine-to-machine interaction over a network. Many existing workflow systems provide such Web Services as a way to access these systems and to enable other system developers to connect and integrate with these. Using such services, the mLogger system may connect with such a third party system to convert memorandum data to the third party system's native format and subsequently log such data into the secondary system's database. In addition, the mLogger system may use certain event subscription services of the third party system to be notified of any changes or modifications to the logged memorandum data and subsequently transmit such changes to Collaborating Users for the given memorandum. Deeper levels of integration are also possible through the development of specialized Plug-in or Add-in computer programs that integrate into the secondary system environment and provide users of such systems with a set of mLogger interfaces and functionality that closely approximate the native mLogger interfaces and functionality. For instance, Plug-in's can be developed to provide the Story Addition and Reply interfaces described above and such Plug-in's can appear in a third party issue tracking system user interface.

Memorandum Data Conversion

In some instances and usage scenarios it may be convenient to convert various memorandum data into other formats which may allow more convenient transmission or viewing. As an example, the collection of memorandum still pictures may be converted into a self-running slide-show (e.g., Microsoft PowerPoint Show® format or PPS). As another example, the Story(s) may be converted to one of the popular video file or streaming formats (e.g., mpeg, Real Time Streaming Protocol). Such videos may then be sent to other users using email or alternatively uploaded to a third party Web application such as a blog or social media service for sharing and viewing.

Automatic Story Creation

In addition to the ability to create a Story manually whereby the user selects, narrates, annotates and draws upon various memorandum data to create the Story, a Story may be created automatically. In this case memorandum data is used to create the Story based on a pre-specified collection of rules contained in a configurable ‘Story Template. For instance, a template may be built into the present invention and configured by the user for the purpose of summarizing a given memorandum into a short video. Such a summarizing Story Template would operate by extracting and converting to video frames, the memorandum title and audio description while displaying one or more memorandum still pictures in the background according to pre-specified timing, placement and size parameters. Such initial video frames would serve as an introduction to the given memorandum. The template would subsequently proceed to append a video slide show of the memorandum still pictures while playing back any audio captions, specified sound tracks and displaying text captions overlaid upon the video. It can be perceived that several Story Templates may be created for various work or recreational occasions or scenarios. Furthermore, a configuration engine can be provided to the user to allow creation and customization of such Templates to fit various user workflows and needs. The output of such process may then be automatically logged to the SM or a third party system such as blogging or social networking system for sharing and viewing by other users. As one benefit, the automated Story creation process described above can provide significant time savings to mobile professionals who follow a finite number of work scenarios and who need to publish memorandum data quickly with as few steps as possible.

In summary, a Story Template combines memorandum data in a pre-specified way according to the rules of the given template and adds necessary introductions, transitions and endings to create a Story out of this data automatically. This has the benefit of faster, more convenient Story creation for people on the go.

Example of Automatic Story Creation for Social Networking

Jane and friends are on a weekend trip in Tofino. On Saturday morning they take a stroll to ‘downtown Tofino’ for brunch and sightseeing. Jane fires up the memorandum application on her iPhone and records a Story title: breakfast in Tofino with Jason, Tom and Hanna. As they walk around, she takes several pictures of the shops, the dock with the colorful kayaks and a blue heron. In the breakfast place she takes a video clip of Jason eating breakfast and the others. She then decides to share this with her friends on Facebook®. She selects the ‘nautical vacation’ theme for her Story. The memorandum application uses the data she has recorded and provided to create the Story using the “nautical vacation” Story template. The outcomes may, for example, be a video Story. The video Story may show the following sequence:

1. Slide with cheerful background and Jane's audio introducing the Story “Breakfast in Tofino” including background music. Would also show any title typed by Jane.

2. Slideshow of pictures taken earlier of the shops and dock including background music and any audio captions Jane may have recorded.

3. Video clip of breakfast gathering.

4. Slide fading out the video.

The output may be transformed into a format suitable for a third party system or site, for example a third party social networking site. For instance, the output may be transformed from one digital video format to another, or the output may be transformed to a video format form some other non-video format (e.g., slideshow). The video may then be posted to a third party site, for instance Facebook® using Jane's credentials. Her friends see the video and can watch and comment on it. Comments can be captured and relayed to her mobile memorandum or Facebook® application.

Various degrees of customization for the template can be provided e.g., background images, music, transitions, etc.

Intelligent Data Processing

Given the large volume of information that a typical person and especially a mobile worker receives, collects, views and responds to on daily basis, there is an increasing need for intelligent processing, categorization and sorting of information. The embodiments described herein with their focus on convenient collection and sharing of information are ideally suited to take advantage of intelligent processing capabilities such as speech and image processing to further facilitate information accessibility and searchability. As one example, the system may be equipped with speech processing functions such that incoming audio information is automatically processed and transcribed to text (typically at the SM). This conversion would enable the user to search for keywords within memorandums and Stories containing audio information. As another example, the SM may be equipped with Optical Character Recognition and/or hand writing recognition capabilities to seek, detect and convert any visual media containing typed or handwritten scripts to text. Other possibilities include use of face and pattern recognition to seek, detect and identify the presence of specific people or objects within the collected memorandum data such as inside any visual media. Again this can aid users in finding specific memorandum data as well as in analysis.

Intelligent User Input Processing

Despite their many advantages, mobile computing devices and smart phones offer relatively limited user interfaces and user input means. It may therefore be beneficial to enable the user to access various functions using alternative convenient means such as spoken commands or visual gestures. As an example, the MCP can be equipped with Speech Recognition capabilities such that a user wishing to create a new memorandum can simply speak a command such as “Voice Memo”. The MCP would respond by launching the new memorandum creation interface and setting the mode to audio recording. The user may further specify the memorandum by speaking the command “Category, Work” which would be interpreted by the MCP as a command to set the memorandum category to Work. In similar fashion the user may continue to record and ultimately save the new memorandum without the need to use the relatively inconvenient or inaccessible controls or input means on the MCD.

Annotation & Bookmarking Prior to Story Recording

Before a Story is recorded it is sometimes beneficial to review and familiarize oneself with the media to be used to develop the Story. As the user is reviewing the media including videos, images and documents, the user may encounter important or noteworthy artifacts or areas or landmarks that the user plans to explain or point out in the Story to be developed. In order to make the process of finding such landmarks more efficient and convenient, the described system and methods may allow the user to place bookmarks at these locations. A bookmark may for instance be the playing time index for a video frame where an important artifact is visible. Similarly a bookmark may be the page number for an important page within a document. In addition to placing bookmarks, the user may also use the screen annotation tools and processing functions available for Story development prior to the commencement of the Story recording process. For instance, the user may review a still picture and decide to add a processing function to zoom in on a certain region of the image, and then add an arrow graphic and a text caption to a specific area in this zoomed image region prior to beginning the Story recording process. The MCP/CP responds by automatically recording the parameters of such annotations and processing as an additional bookmark. In response to the selection of a given bookmark by the user, the MCP/CP navigates the user to the specific point in the associated Content Item and invokes any previously specified processing function and overlays. As a result, during the Story recording process, the user may simply navigate between various bookmarks instead of manually searching for a specific image or playing time index of a video. Since on-screen annotations and processing functions have already been added to the media, the user can be more efficient with the process of recording the Story. Bookmarks created by the user developing the Story can be made available to the user receiving and viewing the Story. In such fashion, the viewing user may use the same bookmarks to quickly navigate between the important points in the Story that were deemed significant by the Creating User while recording his or her Story.

Local Storage, Offline Manipulation & Intelligent Synchronization

As specified earlier, the approach described allows users to have access to a latest or most recent copy of a given memorandum content on the user's own computing device (esp. MCD). While it is often possible to request such data from a central database server located on the RIS every time a user wishes to view or manipulate a given memorandum, this is not always possible or the most efficient method. As an example, there are a number of business productivity applications in use today that provide access to users through a Web-browser executing on mobile devices. These applications are typically difficult and frustrating to use because of the need to download large amounts of data every time the user makes a request. Even though caching techniques help to somewhat alleviate this problem, this relief is temporary since the cache is empties as the user browses other data. Therefore, one valuable feature of the approach described in the present application is its ability to maintain a local copy of the memorandum data on the local user device. This not only makes it more efficient to call up the data (since there is no need to transfer the data from the remote server every time), this also enables viewing and manipulation of memorandum data during periods when there is no connectivity from the device to the server or when connectivity is not feasible (expensive, slow). While the concept of storing local memorandum data on the user device is simple in principle, in practice, this is a complex process as it requires careful synchronization of memorandum data. In fact, this process employs the merging of copies of the same memorandum between the server and the device periodically when the connection is available. This process needs to occur at a lower granularity level than the memorandum itself (typically at the content item or data field level) since some parts of the first copy of a given memorandum may be newer than the same parts in the second copy, while some parts of the first copy may be older than the same parts in the second copy. In other words a simple “newer memo copy overwrites the older memo copy” scheme for synchronization is insufficient. Instead, an intelligent merge scheme is employed at the content/data field level to ensure the resulting synchronized memorandum reflects the latest changes on both sides. The same scheme has the benefit of reducing the volume of data that is exchanged and therefore significantly boosts the overall speed and efficiency of the system. If only an image is modified in a given memorandum on a given MCD, only this image is transferred to the RIS and substituted for the same instead of the entire Memorandum which may contain considerably more data.

As example, the following scenario may occur. A user “Joe” may add an Image1 to an existing memorandum “MemoA”, for example by accessing the system from via an Internet browser. Later, when in transit, the same user may access the system using a mobile client app on his smart phone (with live connection) and open the memorandum MemoA. The system may respond by comparing a local copy of the memorandum MemoA with a copy on the server and updates the local copy on the smart phone such that the smart phone now has a copy of Image1. The user then boards a plane and begins to work on the memorandum MemoA, adding a Story(i) about Image1 using the MCP on smart phone (now disconnected from network) and deleting another image previously added (Image2). The system responds by saving a local copy of the memorandum MemoA, updated with the new Story and deletes Image2 from this copy. While the user Joe is in flight, another user “Robert” with access to the memorandum MemoA adds an image3 as well as Story(ii) by accessing the system via an Internet browser at the office. Once the plane lands, the user Joe's smart phone detects a communications connection. At this point, the smart phone prompts the user Joe (or automatically) connects to the Server. The client and server initiate the merge sequence which involves the granular comparison and exchange of data between the client and the server for Memorandums including the memorandum MemoA. In this fashion the addition of Story(i) and deletion of Image2 are reflected to the server copy of the memorandum Memo A while the addition of Image3 and Story(ii) are reflected from the server to the local copy of the memorandum MemoA on Joe's smart phone.

Context-Sensitive Granular Data Exchange

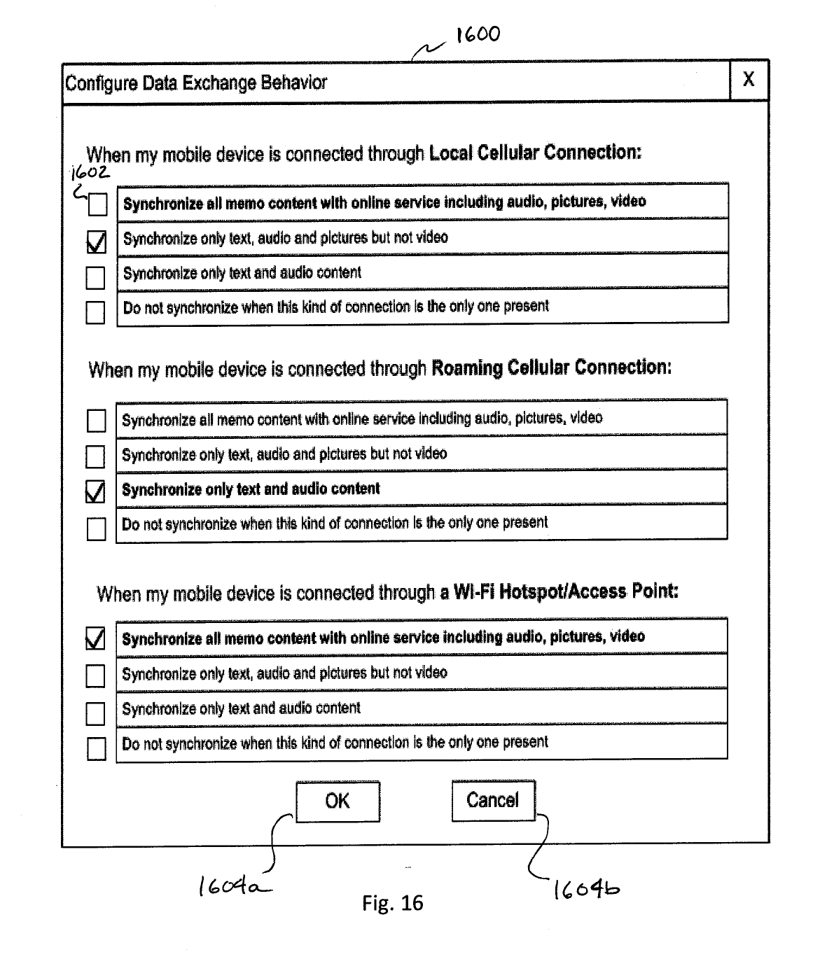

Modern mobile computing devices are typically capable of connecting to the Internet using multiple communication modes and protocols. For instance a smart phone device can typically use a cellular connection (e.g., 3G) under a carrier-specific data plan to connect. The same device may increasingly use a Wi-Fi wireless (802.11.x) connection to connect to the Internet via a wireless access point. When the smart phone device is in a different geographical location other than the local region where the data plan is domiciled, it typically enters a “roaming” mode whereby it is connecting via another participating cellular carrier's network. In such cases, the cost of connection and data transfer typically rises quite significantly. Therefore a need arises to control the connectivity and data transfer behavior depending on the type of connectivity present or available. For instance, the system may allow a user to define whether a given mobile client should connect to the RIS when a specific type of connection is present or available and if so, what type or volume of data to exchange. The Context Sensitive Granular Data Exchange scheme enables users to customize the behavior of the system to suit their specific data plan characteristics and preferences at the content item granularity level. FIG. 16 shows a user interface element in the form of a dialog box or control panel 1600 that allows a user to specify or customize connectivity behavior of a communications device. The dialog box or control panel 1600 has a number of fields 1602 (only one called out in FIG. 16) which allow the user to set, select or specify certain settings. The dialog box or control panel 1600 also has a number of user selectable icons, for example an OK icon 1604a to accept settings or specifications and a cancel icon 1604b to cancel any changes made to the settings or specifications. In addition to setting or specifying a type of data to be exchanged, similar settings or specifications can allow the user to define upper size limits for the data to be exchanged. In addition to connection type, other parameters such as geographical location and time of day may also be used to impact the type and volume of data to be exchanged.

Email-Based System Access

A problem arises when a user especially a mobile user does not have access to an MCD or CSC that allows that user to interact with the system using the rich CP or MCP interface. As an example, a given mobile user may be utilizing an older generation smart phone device which is equipped only with email capability and which does not provide the processing power or functionality to install and run the MCP. In such cases, the given user may still need to access basic capabilities of the system while on the road. An Email-based System Access scheme may enable such basic access and data manipulation. The scheme operates by allowing users to send emails to the system at a pre-defined address or set of addresses, as well as to reply to email messages that are auto generated and sent to the user by the system. When such email messages or replies are received by the SM executing on the RIS, the content of the message is parsed and depending on the presence of keywords or phrases and the context, appropriate actions are taken by the system. As an example, a mobile user (Joe Smith) may send an email to an address defined specifically for him on the system (jsmith@memologger.com) with the subject reading “New Memo: Remind Jack to Inspect Facia” and optionally a body providing further written description. When such an email is received by the system, the subject is parsed whereby the string “New Memo” is encountered. In this case, the system determines the user's intention to be one of creating a new memorandum and therefore uses the following segment of the string as the Memo Title and the body of the email as the Memo Notes to create a new memorandum entry for Joe Smith under his system account. As another example, Joe may receive an auto-generated email from the system about a comment that another user has made about one of Joe's memorandums. Joe may proceed to reply to this email message with a reply comment of his own while leaving the subject line of the email intact. When the reply is received by the SM, the SM interprets the subject line as Joe's intention to reply to the other user's comment and therefore the system appropriately creates and enters a reply to the other user on Joe's behalf using the reply email's body. In this fashion a user may continue to remain informed and be able to interact with the system when a rich interface to the system is not available due to device or connectivity limitations.

Training or Technical Support Applications

The above described systems and methods may be employed in training or technical support applications. For example, such may be advantageously used to step or walk a trainee or user through the use of a product or software application.

During the story creation process the user may also elect to use the controls on the story creation user interface to launch a given software application residing on the MCD/CSC. The system allows the user to run the software application and operate the controls of such software application to call up its various functions and screens in the context of the story creation process. The system can record the progression of various screens of the software application as a series of still pictures or video. The system will also record a time-indexed progression of all user actions, annotations and drawings. The still pictures or video of software application's screens and the time-indexed progression of user actions are used in the story creation process. A software application may be installed natively on the MCD/CSC or may be accessed over a network or via a browser in case of a web software application.

Thus, a trainer may easily create training tools to train a trainee in the use of a new software package or new version of a software package. Likewise, support personnel my create tools to assist a user in configuring a computer to operate with a particular software package or to configure a computer in a desired fashion. The trainer or support person may operate the particular software package, capturing screen shots at various steps, and providing appropriate graphics or text on the screen shots along with suitable narration.

### CONCLUSION

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating a server in a networked collaborative environment, the method comprising:
receiving a first memorandum creation request to create a first memorandum at the server via a network from a first end user processor-based device remotely located from the server; and
in response to receiving the first memorandum creation request,
creating a first memorandum record by the server, the first memorandum record corresponding to the first memorandum, the first memorandum record including metadata specifying at least one of a title or a description of a subject of the first memorandum and at least one content item reference specifying at least one content item of the first memorandum;
creating at least one content item record including metadata specifying at least one of a date, a time or a geographical location and a reference to a piece of content with a content type selected from audio content, still image content, video content, document content and a Web content;
creating at least one media record including an original source data file reference and at least one pointer to a set of source data; and
providing a notification of the availability of the first memorandum from the server via a network to at least a second end user processor-based device remotely located from the server, the second end user processor-based device different from the first end user processor-based device.

2. The method of claim 1, further comprising:
receiving a first story creation request to create a first story associated with the first memorandum at the server via a network from a first end user processor-based device remotely located from the server; and
in response to receiving the first story creation request, creating a first story record by the server, the first story record corresponding to the first story, the first story record including a time index and a mapping of a number of pieces of content and a number of media objects created by a user to the time index.

3. The method of claim 2 wherein the media objects include at least one of a video file, an audio file, a visual annotation or a drawing created by the user and related to the at least one piece of content.

4. The method of claim 2 wherein creating a first story record by the server includes creating the first story record including a set of metadata specifying at least one of a date, a time, or a geographic location associated with the first story.

5. The method of claim 2 wherein creating a first story record by the server includes creating the first story record including an ambient parameter or a set of user credentials.

6. The method of claim 2, further comprising:
providing a notification of the availability of the first story from the server via the network to at least a second end user processor-based device remotely located from the server, the second end user processor-based device different from the first end user processor-based device.

7. The method of claim 2 wherein creating a first story record by the server includes creating a screen annotation record that identifies a screen annotation created by the user.

8. The method of claim 2 wherein creating a first story record by the server includes creating a screen annotation record that identifies a screen annotation in the form of at least one of a label, reference to a graphic file, or reference to an animation file created by the user.

9. The method of claim 2 wherein creating a first story record by the server includes creating drawing data record including a time-indexed array of screen coordinates traversed by the user.

10. The method of claim 2, further comprising:
outputting at least one story in a format employed by at least one third party social networking or collaboration service.

11. A method of operating a first end user processor-based device in a networked collaborative environment, the method comprising:
presenting a memorandum specification user interface on a display of the first end user processor-based device, the memorandum specification user interface including at least one metadata specification field configured to allow a user to enter metadata for a memorandum in the form of at least one of a title or a description of the memorandum, at least one content specification field configured to allow the user to specify at least one piece of content for the memorandum where a type of content selectable by the user includes still image content, video image content, audio content, document content, and electronic mail content, and at least one participant specification field configured to allow the user to identify each of a number of participants having authority to at least one of view, modify or respond to the memorandum;
receiving a number of user selections indicative of the metadata, the at least one piece of content and the at least one participant for the memorandum; and
transmitting a memorandum specification request to a processor-based server remotely located from the first end user processor-based device, the memorandum specification request specifying the at least one piece of content and the at least one participant for the memorandum.

12. The method of claim 11, further comprising:
presenting a story specification user interface on the display of the first end user processor-based device, the story specification user interface including at least one metadata specification field configured to allow a user to enter metadata for a story in the form of at least one of a title or a description of the story; a memorandum content field that displays user selectable content icons for each piece of content of the memorandum, a story board field configured to have a representation of user selected ones of the at least one piece of content displayed therein, and at least one set of user selectable content operation icons that are specific to the content type of the piece of content identified by the representation in the story board field, selection of which causes an operation to be performed on the piece of content.

13. The method of claim 12 wherein presenting a story specification user interface on the display of the first end user processor-based device includes presenting the representation of the at least one user selected piece of content in the story board field in response to a user swiping motion on a touch-screen display of the first end user processor-based device, the user swiping motion moving from at least proximate the use selected content icon toward the story board field.

14. The method of claim 12 wherein when the content type is video presenting the at least one set of user selectable content operation icons includes presenting at least three user selectable icons the selection of which cause the piece of content to play, pause and stop, respectively.

15. The method of claim 12 wherein presenting the story specification user interface further includes presenting at least one user selectable narration icon selection of which allows the user to record at least one of an audio or a video narration for the piece of content identified by the representation in the story board field and logically associate the recorded audio or the video narration with the piece of content.

16. The method of claim 12 wherein presenting the story specification user interface further includes presenting a set of user selectable markup icons selection of which allows placement of graphic or textual indicator on a portion of the representation in the story board field.

17. The method of claim 16 wherein presenting a set of user selectable markup icons includes presenting three user selectable icons the selection of which causes placement of text, an arrow, a circle, respectively, on a selected portion of the representation in the story board field.

18. The method of claim 12 wherein presenting the story specification user interface further includes presenting at least one user selectable bookmarking icon selection of which allows the user to identify a portion of the piece of content identified by the representation in the story board field with a logical marker.

19. The method of claim 18 wherein presenting the story specification user interface further includes presenting at least one field that displays each user selectable bookmark created by a user for the piece of content identified by the representation in the story board field.

20. The method of claim 12 wherein the at least one content specification field is configured to allow the user to specify the at least one piece of content for the memorandum by selecting an existing piece of content, recording a new piece of content and importing a new piece of content.
